(19) United States
(12) Patent Application Publication
(10) Pub. No.: US 2012/0051241 A1
(43) Pub. Date: Mar. 1, 2012

(54) Communication system with a plurality of nodes communicably connected for communication based on NRZ (non return to zero) code

(75) Inventors: Hiroyuki Mori, Obu-shi (JP); Masayoshi Satake, Okazaki-shi (JP); Tomohisa Kishigami, Obu-shi (JP); Toshihiko Matsuoka, Aichi-ken (JP)

(73) Assignees: DENSO CORPORATION, Kariya-city (JP); Nippon Soken, Inc., Nishio-city (JP)

(21) Appl. No.: 13/199,438

(22) Filed: Aug. 30, 2011

(30) Foreign Application Priority Data
Aug. 31, 2010 (JP) 2010-194664
Sep. 2, 2010 (JP) 2010-196844
Sep. 15, 2010 (JP) 2010-206792

(51) Int. Cl. H04L 12/26; H04J 3/22

(52) U.S. Cl. 370/252; 370/465

(57) ABSTRACT

In a communication system, plural nodes are communicably connected to a communication line and mutually communicate based on an NRZ (Non Return to Zero) code. Each node detects, as a data frame head, a dominant level when a signal on the line changes to a dominant level during a stand-by state of the line. An activation frame is transmitted during a sleep mode. The activation frame has an activation pattern area storing therein a bit pattern showing that the frame is the activation frame, a specific pattern area storing therein a bit pattern showing a node to be activated, a boundary position satisfying a predetermined boundary condition and being a boundary between the activation and specific pattern areas. Each node performs a switchover from the sleep mode to a normal mode based on the bit patterns in the activation and specific pattern areas and information given by the boundary position.

### CROSS-REFERENCE TO RELATED APPLICATION

This application is based on and claims the benefit of priorities from earlier Japanese Patent Application Nos. 2010-196844, 2010-194664 and 2010-206792 filed Sep. 2, Aug. 31 and Sep. 15, 2010, respectively, the descriptions of which are incorporated herein by reference.

### BACKGROUND

1. Technical Field

The disclosure relates to a communication network configured by nodes having a sleep/wake-up function, and in particular to a technique for individually starting nodes which are in a sleep mode.

2. Related Art

It is known to use a protocol in an on-vehicle LAN to realize communication between a plurality of nodes installed in the vehicle.

Among such on-vehicle LAN protocols, a protocol called CAN (Controller Area Network) is standardized (ISO11898-1).

In CAN, “dominant” and “recessive” are defined as signal levels in a communication channel. When any one of nodes has outputted a signal having a dominant level, the signal level in the communication channel is adapted to turn dominant.

CAN protocol also specifies that, when signals of the same level continue for five bits, a stuff bit having an inverted signal level is inserted to enable clock error correction with a signal received via a communication channel.

Further, CAN protocol defines a physical layer having a sleep/wake-up function (ISO11898-5). Specifically, CAN protocol provides operational modes which are sleep mode and normal mode. In the sleep mode, communication function is stopped in order to save power. In the normal mode, use of a communication channel is enabled. It is defined in CAN protocol that, when a dominant signal is detected in a communication channel, a node in the sleep mode wakes up and transitions into the normal mode.

A communication system having such a wake-up/sleep function suffers from a problem in the case where some nodes are in a sleep mode (hereinafter, such a node is referred to as a “suspended node”). Specifically, while suspended nodes are allowed to be in a sleep mode, communication cannot be established between nodes in a normal mode, i.e. in an ordinarily used operational mode (hereinafter, such a node is referred to as an “activation node”). Further, in such a case, it has been a problem that necessary nodes cannot be exclusively woken up and used.

More specifically, carrying out communication means that a dominant signal shows up in a communication channel. Therefore, when activation nodes carry out communication with each other, all the suspended nodes are activated.

Taking account the problem set forth above, JP-A-2005-529393 discloses a technique for use in activating (waking up) the entire ECU. Specifically, in this technique, a transceiver of a suspended node monitors the bus. When the transceiver detects that the bus is not in an idle mode, the protocol controller analyzes whether a received frame is activated (power supply is resumed) in a limited way. Then, when the protocol controller has determined that the received frame is a frame for waking up the suspended node in question, the entire ECU is activated (woken up).

In the meantime, the protocol controller has to individually identify bits configuring a frame. For the individual identification, the protocol controller is ordinarily required to receive clocks from a high-accuracy clock source. In other words, in order to activate the protocol controller, a high-accuracy clock source has to be simultaneously activated.

When communication between the activation nodes (i.e. non-idle mode of the bus) is continued under the condition where activation nodes and suspended nodes are mixed, the protocol controller and the high-accuracy clock source keep operating in each of the suspended nodes during the continuation of the communication. Thus, in spite of being suspended nodes (not being activated as ECUs), unignorable electric power is problematically kept being consumed.

### SUMMARY

In light of the problems set forth above, it is desired that a communication system is able to individually wake up nodes which are in a sleep mode, and an activation frame of a node in question is identified without increasing power consumption of nodes which are in a sleep mode.

An exemplary embodiment provides a communication system comprising: a communication line having a stand-by state in which a signal in the communication line has a recessive level which lasts over a period of time corresponding to the number of allowed sequential bits of the signal; a plurality of nodes communicably connected to the communication line and configured to communicate with each other based on an NRZ (Non Return to Zero) code, each of the nodes detecting, as a head of a data frame transmitted into the communication line, a dominant level of the signal in the communication line when the signal changes to the dominant level during the stand-by state of the communication line, and operating based on, as an operation mode, a sleep mode in which the node stops communication via the communication line and a normal mode in which the node is allowed to perform the communication via the communication line, a predetermined activation frame being transmitted into the communication line during the sleep mode, wherein the activation frame is produced from the data frame and has an activation pattern area, a specific pattern area, and a boundary position, the activation pattern area storing therein a bit pattern showing that the frame transmitted into the communication line is the activation frame, the specific pattern area storing therein a bit pattern showing a node to be activated among the plurality of nodes, the boundary position satisfying a predetermined boundary condition for the bit pattern in the activation frame and being a boundary between the activation pattern area and the specific pattern area; and each of the nodes is configured to perform a switchover of the operation mode from the sleep mode to the normal mode based on the bit patterns in the activation pattern area and the specific pattern area and information given by the boundary position.

By way of example, the activation frame has the activation pattern area in which a unique bit pattern is provided, the unique bit pattern having a bit length counted from the head of the activation frame to a boundary point, the bit length being different from a predetermined activation period length, the boundary point serving as the boundary position, and each of the nodes is configured to i) measure the bit length from the head of the activation frame transmitted via the communication line when the operation mode is in the sleep mode, ii) determine whether or not requirements are met, the requirements consisting of a) a requirement that the measured bit length is equal to or greater than the activation period length and b) a requirement that the bit pattern from the specific pattern area of the activation frame agrees with a bit pattern assigned to the node which is in the measurement, the assigned bit pattern designating the node as a node whose operation mode should be switched over from the sleep mode to the normal mode, and iii) allow the operation mode of the node to be switched from the sleep mode to the normal mode.

It is also preferred that the frame has a boundary area in which two or more bits which have the same signal level continues, the activation pattern area is given as an area ranging from the head to the boundary area in the activation frame, the specific pattern area is given as part of an area ranging from the boundary area to a tail of the activation frame in the activation frame, wherein the specific pattern area has a bit pattern in which bits having the dominant levels and bits having the recessive levels are mapped alternately to each other, and each of the nodes is configured to i) measure the number of edges to be counted when the operation mode is in the sleep mode, the edges being at least one of an edge at which the signal changes from the recessive level thereof to the dominant level thereof and an edge at which the signal changes from the dominant level thereof to the recessive level thereof, ii) determine whether or not requirements are met, the requirements consisting of a) a requirement that the number of edges counted in the activation pattern area of the activation frame transmitted into the communication line is equal to the number of times of activation defined by the bit patter in the activation pattern area and b) a requirement that the bit pattern from the specific pattern area of the activation frame agrees with a bit pattern assigned to the node which is in the measurement, the assigned bit pattern designating the node as a node whose operation mode should be switched over from the sleep mode to the normal mode, and iii) allow the operation mode of the node to be switched from the sleep mode to the normal mode when it is determined that the requirements are met.

It is also preferred that the activation frame is a first frame having a data area whose bit length is the shortest, the frame including a second frame whose frame length is not the shortest, the specific pattern area is given as an area ranging from the head of the activation frame to a boundary point serving as the boundary position, and each of the nodes is configured to i) measure a frame length and an activation period length of the frame transmitted via the communication line when the operation mode is in the sleep mode, ii) determine whether or not requirements are met, the requirements consisting of a) a requirement that the measured frame length is greater than a frame length of the activation frame and lower than or equal to the activation period length of the second frame, and b) a requirement that a feature quantity (i.e., quantity showing a feature (or characteristic) of the bit pattern) obtained from the bit pattern in the specific pattern area agrees with a bit pattern assigned to the node which is in the measurement, the assigned bit pattern designating the node as a node whose operation mode should be switched over from the sleep mode to the normal mode, and ii) allow the operation mode of the node to be switched from the sleep mode to the normal mode when it is determined that the requirements are met.

In the communication system configured in this way, it is determined whether or not a frame in the communication channel has a unique pattern (here, a pattern with a unique number of count edges, in an activation pattern area). Thus, the frame is determined to be an activation frame or not, without interpreting (decoding) the individual bits configuring the frame.

Thus, in the communication system of the disclosure, it is not required to operate a protocol controller and a high-accuracy clock source, in determining whether or not a node in a sleep mode has received an activation frame. Accordingly, power consumption of a node in a sleep mode is reduced to a great extent.

Further, all the nodes that have received respective activation frames are not unconditionally activated, but only those nodes specified by the bit patterns detected in the respective specific pattern areas are activated. Accordingly, those nodes which are not required to be activated will not be unnecessarily activated. Thus, power consumption of the entire communication system is reduced.

Preferably, the specific pattern area stores therein signals which are coded every unit block consisting of a plurality of bits. In this case, the bit patterns can be processed on a unit block basis. Thus, when the plurality of bits are M number of bits and the bits are decoded using clocks, the accuracy required for the processing may be only 1/M of that of the clocks for an ordinarily used protocol controller.

Also, in this case, for example, a unit block may be configured by three or more bits and information corresponding to one bit may be indicated by two types of codes having different duty ratio. For example, when a unit block is configured by three bits, the two codes may be “001” and “011” and when configured by four bits, the two codes may be “0001” and “1110”.

The other operations and advantages of the disclosure are readable clearly from the following various embodiments described with the accompany drawings.

### BRIEF DESCRIPTION OF THE DRAWINGS

In the accompanying drawings:

FIG. 1 is a block diagram illustrating a communication system to which a first embodiment of the present invention is applied;

FIG. 2 is an explanatory diagram illustrating a configuration of a data frame in the communication system;

FIG. 3A is a schematic diagram illustrating a configuration of a transceiver in the communication system partially including circuit diagram;

FIG. 3B is a schematic block diagrams illustrating an activation frame detector included in the transceiver;

FIG. 4A is a circuit diagram illustrating a configuration of a stand-by state detection circuit of the activation frame detector;

FIG. 4B is a timing diagram illustrating an operation of each of the components of the stand-by state detection circuit;

FIG. 5 is a circuit diagram illustrating a configuration of an activation pattern determination circuit;

FIG. 6 is a timing diagram illustrating an operation of the activation pattern determination circuit of the activation frame detector at the time of receiving an activation frame;

FIG. 7 is a timing diagram illustrating an operation of the activation pattern determination circuit of the activation frame detector at the time of receiving a non-activation frame;

FIG. 8 is a circuit diagram illustrating a specific pattern determination circuit of the activation frame detector;

FIGS. 9A and 9B are timing diagrams illustrating an operation of an edge detection circuit and a duty ratio decoder, respectively;

FIG. 10 is a timing diagram illustrating an operation of the specific pattern determination circuit when an assigned pattern coincides with a specific pattern;

FIG. 11 is a timing diagram illustrating an operation of the specific pattern determination circuit when an assigned pattern does not coincide with a specific pattern;

FIG. 12 is a block diagram illustrating another configuration example of a specific pattern determination circuit;

FIG. 13 is a circuit diagram illustrating a configuration of an activation pattern determination circuit according to a second embodiment of the present invention;

FIG. 14 is a timing diagram illustrating an operation of the activation pattern determination circuit of the activation frame detector at the time of receiving an activation frame;

FIG. 15 is a timing diagram illustrating an operation of the activation pattern determination circuit of the activation frame detector at the time of receiving a non-activation frame;

FIG. 16 is a circuit diagram illustrating a specific pattern determination circuit of the activation frame detector;

FIGS. 17A and 17B are timing diagrams illustrating an operation of an edge detection circuit and a duty ratio decoder, respectively;

FIG. 18 is a timing diagram illustrating an operation of the specific pattern determination circuit when an assigned pattern coincides with a specific pattern;

FIG. 19 is a timing diagram illustrating an operation of the specific pattern determination circuit when an assigned pattern does not coincide with a specific pattern;

FIG. 20 is a block diagram illustrating another configuration example of a specific pattern determination circuit according to a third embodiment of the present invention;

FIG. 21 is a timing diagram illustrating an operation of an activation pattern determination circuit at the time of receiving an activation frame;

FIG. 22 is a timing diagram illustrating an activation pattern determination circuit at the time of receiving a non-activation frame;

FIG. 23 is a schematic block diagram illustrating another example of a specific pattern determination circuit;

FIG. 24 is an explanatory diagram illustrating a configuration of a data frame in the communication system according to a fourth embodiment of the present invention;

FIG. 25 is a schematic block diagram illustrating an activation frame detector included in the transceiver;

FIG. 26 is a circuit diagram illustrating a configuration of a feature quantity detection circuit;

FIGS. 27A and 27B are timing diagrams each illustrating an operation of the feature quantity detection circuit;

FIGS. 28A and 28B are circuit diagrams illustrating a configuration of a frame-length detection circuit and a wake-up determination circuit, respectively;

FIGS. 29A and 29B are timing diagrams illustrating an operation of the frame-length detection circuit and the wake-up determination circuit, respectively;

FIG. 30 is a circuit diagram illustrating a configuration of a feature quantity detection circuit according to a fifth embodiment of the present invention;

FIG. 31 is a timing diagram illustrating an operation of the feature quantity detection circuit in the case of receiving a frame which is set with an ID for activating the ECU in question;

FIG. 32 is a timing diagram illustrating an operation of the feature quantity detection circuit in the case of receiving a frame which is set with an ID other than the ID for activating the ECU in question;

FIG. 33 is a circuit diagram illustrating a configuration of an end timing detection circuit that is a part of a feature quantity detection circuit according to a sixth embodiment of the present invention;

FIG. 34 is a timing diagram illustrating an operation of the feature quantity detection circuit in the case of receiving a frame which is set with an ID for activating the ECU in question; and

FIG. 35 is a timing diagram illustrating an operation of the feature quantity detection circuit in the case of receiving a frame which is set with an ID other than the ID for activating the ECU in question.

### DETAILED DESCRIPTION OF THE PREFERRED EMBODIMENTS

With reference to the accompanying drawings, hereinafter will be described various embodiments of the present invention.

### First Embodiment

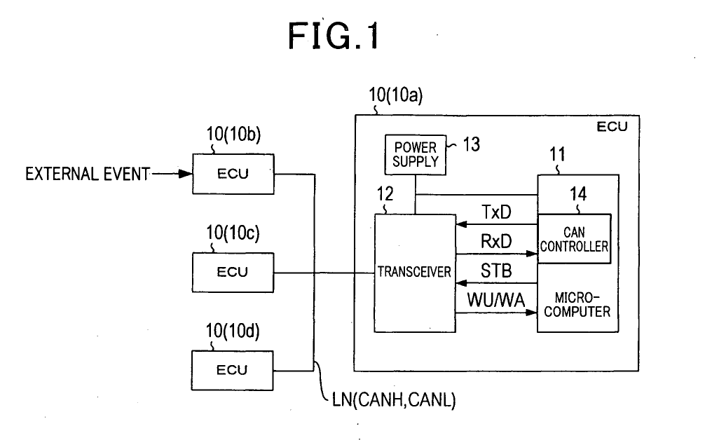

With reference to FIGS. 1-12, a first embodiment will now be described.

FIG. 1 is a block diagram illustrating an on-vehicle configuration of a communication system 1 that uses a CAN (Controller Area Network) protocol as a communication protocol.

As shown in FIG. 1, the communication system 1 is configured connecting a plurality of electronic control units 10a, 10b, 10c, . . . installed in a vehicle via a common communication channel LN so that the electronic control units can communicate with each other. In the communication system 1, each of these electronic control units 10a, 10b, 10c, . . . functions as a node. In the description set forth below, these electronic control units are referred to as “ECUs 10a, 10b, 10c, . . . ”. Further, when one or some of these ECUs 10a, 10b, 10c, . . . is/are mentioned without particularly indicating specific reference numerals, or mentioned as representative(s), the ECU(s) is/are referred to as “ECU(s) 10”.

The communication channel LN is configured by a pair of buses CANH and CANL, with both ends of each of these buses being terminated by terminating resistors, not shown. In the communication channel LN, an NRZ (Non-Return-to-Zero) code is transmitted by a differential signal. The differential signal expresses “dominant” (e.g., “0”) that is a superior signal level in the communication channel LN or expresses “recessive” (e.g., “1”) that is an inferior signal level in the communication channel LN, depending on the potential difference between the buses CANH and CANL.

The ECUs 10a, 10b, 10c, 10d . . . include various ECUs, such as an engine ECU that controls an engine, a brake ECU that controls a brake, a steering ECU that controls a steering, a suspension ECU that controls a suspension and an ECU that controls switching on/off of lights. In FIG. 1, only four ECUs 10 are indicated, however, as a matter of course, the number of the ECUs 10 is not limited to this number.

One of the ECUs 10 (ECU 10b here) is configured such that an external event that triggers activation of the entire communication system 1 is inputted from an on-vehicle device, not shown.

For example, an external event may be generated when the vehicle doors are opened/closed, or when a switch provided for starting the communication system 1 is operated.

Further, the ECU 10 has a normal mode that is a normal operational mode in which a controlled object is controlled, and a sleep mode that is an operational mode in which communication is stopped to suppress power consumption. The ECU 10 is configured such that mode will transition between the normal mode and the sleep mode.

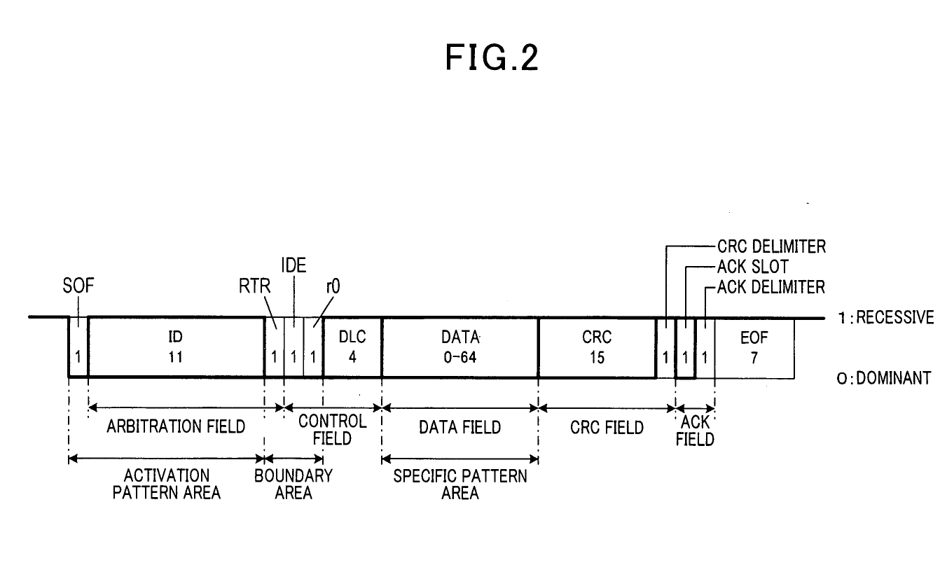

FIG. 2 is an explanatory diagram illustrating a configuration of a data frame used for data transmission/reception in the communication system 1.

As shown in FIG. 2, a data frame includes a 1-bit start-of-frame (SOF) at the head and a 7-bit end-of frame (EOF) at the end. The data frame includes, in between the SOF and EOF, an arbitration field, a control field, a data field, a cyclic redundancy check (CRC) field and an acknowledge check (ACK) field.

The arbitration field consists of an 11-bit identifier (ID) and a 1-bit remote transmission request (RTR). The control field consists of a 1-bit identifier extension (IDE), a reserved bit (r0) of 1 bit and a 4-bit data length code (DLC). The data field consists of data of 0 to 64 bits (i.e., 0 to 8 bytes). The CRC field consists of a 15-bit CRC sequence and a 1-bit CRC delimiter. The ACK field consists of a 1-bit ACK slot and a 1-bit ACK delimiter.

As indicated by thick solid lines in FIG. 2, in a data frame having a standard format, SOF, RTR bit, IDE bit and r0 are constantly dominant, while CRC delimiter, ACK delimiter and EOF are constantly recessive. Specifically, the data frame includes an area in which three bits (RTR, IDE and r0) are necessarily consecutively dominant. This area is hereinafter referred to as a “boundary area”. An area (SOF and ID) on the side of the head with reference to the boundary area is referred to as an “activation pattern area”. The data field is also referred to as a “specific pattern area”.

The EOF of a data frame is followed by an intermission (not shown) configured by three recessive bits. Transmission of a data frame is adapted to start from the bit that follows the intermission. Also, when signals of the same level continue for N (N=5 here) bits in a data frame, a stuff bit having an inverted signal level is adapted to be inserted.

The communication system 1 uses a data frame in which ID is set to 0x555. This data frame serves as an activation frame and is used in activating (waking up) the ECU 10 whose operational mode is a sleep mode. In other words, use of this ID is inhibited between the ECUs 10 whose operational mode is a normal mode.

The activation pattern area (SOF and ID) is expressed by a bit pattern as <0>10101010101, in which <0> expresses SOF. Setting ID to 0x555 (ID=0x555) means that the activation pattern includes a unique bit pattern in the activation pattern area, with the number of edges at which a dominant level turns to a recessive level (hereinafter referred to as “count edges”) is maximized (six times).

In the specific pattern area (data field) of the activation frame, a specific pattern is set to individually specify the ECU 10 to be activated. In the specific pattern, four bits form a unit block. A predetermined code pattern is used for each unit block to express a 1-bit value.

The code pattern is set such that an edge at which a recessive level turns to a dominant level (hereinafter referred to as an “edge of focus”) is detected in a boundary between unit blocks. Specifically, a code pattern of “0111” is used as code pattern expressing data “0”, and a code pattern of “0001” is used as a code pattern expressing data “1”. More specifically, two code patterns having a different duty ratio are used to express a 1-bit value. In the following description, a data obtained by decoding the code pattern of a specific pattern area is also referred to as a “specific code”.

The end of the last unit block of a specific pattern area coincides with a boundary between the specific pattern area and the CRC sequence. Thus, an edge of focus may not necessarily be detected. Accordingly, the last unit block is set with a terminating pattern “0010” or “0100”, not the code pattern corresponding to the data “0” or “1”. In other words, the terminating pattern may be set such that a total of two edges of focus are reliably detected, i.e. one at the head-side boundary of the unit block and one at a position other than the end-side boundary of the unit block.

The data length code (DLC) of an activation frame is set such that the end of the DLC area necessarily is recessive and that change from a recessive level to a dominant level is necessarily detected at the boundary between the control field and the data field (i.e. the head of a first unit block). To this end, the LDC of an activation frame is set to odd-number bytes, or to eight bytes with the end of the LDC area being recessive.

Specifically, the code length of a specific code (number of unit blocks) is obtained from a formula:

p (byte)×8 (number of bits in one byte)/4 (number of bits in unit block)−1 (terminating pattern)

where p indicates a data length. Specifically, the code length of a specific code is selected from 1 (when p=1), 5 (when p=3), 9 (when p=5) and 13 (when p=7) and the like.

Referring to FIG. 1 again, the ECU 10 includes a microcomputer 11, a transceiver 12 and a power supply circuit 13. The microcomputer 11 performs a control process for controlling each of sections of the vehicle and performs a process for establishing communication with other ECUs. The transceiver 12 is connected to the communication channel LN to output data (transmission frame) TxD given by the microcomputer 11 to the communication channel LN, receive data (reception frame) RxD in the communication channel LN and input the data RxD into the microcomputer 11. The power supply circuit 13 supplies power to the microcomputer 11 and the transceiver 12.

Also, the microcomputer 11 is configured to supply a stand-by signal STB to the transceiver 12 to switch the operation of the transceiver 12. The transceiver 12 is configured to supply a wake-up signal WU or WA to the microcomputer 11 to indicate reception of an activation frame via the communication channel LN.

Of the two wake-up signals WU and WA, the wake-up signal WA is used by the ECU 10 (e.g., an ECU having a function of monitoring an on-vehicle LAN, or an ECU having a gateway function of connecting LANs) which is necessarily required to be activated when a frame is transmitted to the communication channel LN. In the following description, the wake-up signal WA is also referred to as a “random wake-up signal”.

The wake-up signal WU is used by the ECU 10 which has to wake up only when an activation frame set with a specific pattern specifying the ECU 10 in question is received. In the following description, the wake-up signal WU is also referred to as a “specific wake-up signal”.

The configuration of the ECU 10 shown in FIG. 1 is common to all of the ECUs 10. Meanwhile, each of the ECUs 10 has a configuration that realizes a function specifically assigned to the ECU 10.

The microcomputer 11 has a known configuration including CPU, ROM, RAM and JO port. The microcomputer 11 also includes a CAN controller 14 that transmits/receives frames, performs arbitration control for determining which of frames should be preferentially processed, carries out a process of coping with communication errors, and performs other processes, in accordance with the CAN protocol.

The microcomputer 11 also includes a clock circuit (not shown) that generates operation clocks for operating the CPU and the CAN controller 14. It is so configured that the operation of the clock circuit (and further the operation of the CPU) is stopped by interrupting power supply to the clock circuit. An operational mode in which the clock circuit is operated corresponds to the normal mode, while an operational mode in which the operation of the clock circuit is stopped corresponds to the sleep mode.

The microcomputer 11 sets the stand-by signal STB to a non-active state when the operational mode is a normal mode, and to an active state when the operational mode is a sleep mode.

In a normal mode, the microcomputer 11 carries out various assigned controls. When sleep conditions are met while the assigned controls are carried out, a sleep process is performed.

In the sleep process, the stand-by signal STB is turned active to stop the communication function of the transceiver 12, and to activate an activation frame monitoring function of the transceiver 12. Then, power supply to the clock circuit is interrupted to stop the operation of the microcomputer 11, to thereby transition the operational mode into a sleep mode.

When the wake-up signal WU (or WA) from the transceiver 12 turns active (exhibits high level in the present embodiment) in a sleep mode, the microcomputer 11 activates the clock circuit. With the activation of the clock circuit, the CPU starts operation to perform a wake-up process.

In the wake-up process, the stand-by signal STB is turned non-active to stop the activation frame monitoring function of the transceiver 12, and to activate the communication function of the transceiver 12. Thus, the operational mode of the ECU 10 transitions into a normal mode.

In the ECU 10 having a function of waking up another ECU, when activation conditions predetermined in a normal mode are met, an activation frame set with a specific pattern of the ECU to be activated is transmitted to activate (wake up) the ECU to be activated.

When the ECU 10b in a sleep mode receives an external event (one of activation conditions), the microcomputer 11 activates the clock circuit, performs the wake-up process described above, and transmits an activation frame, similar to the case where the wake-up signal WU (or WA) has turned active.

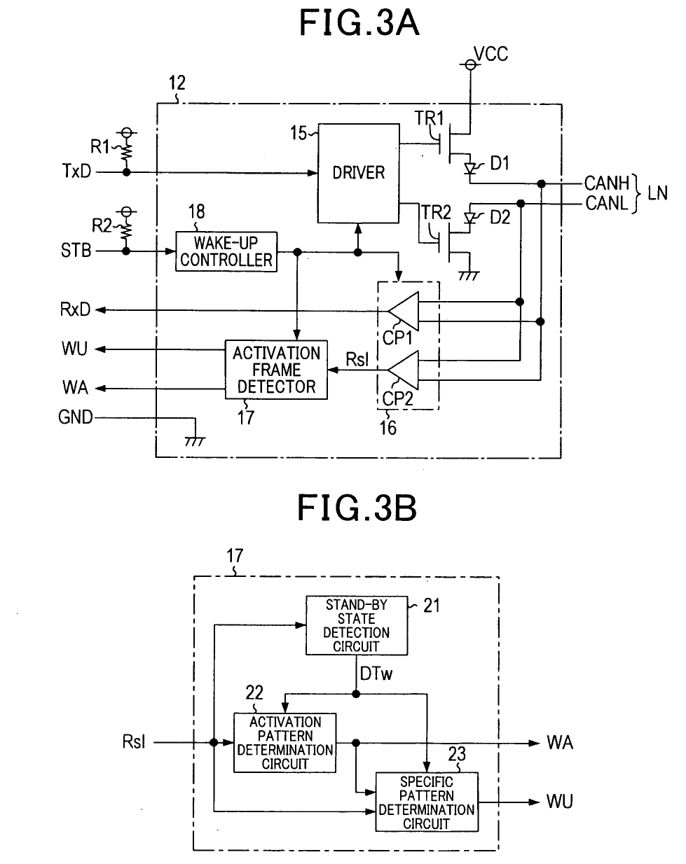

FIG. 3A is a schematic block diagram illustrating the configuration of the transceiver 12, partially including a circuit diagram.

As shown in FIG. 3A, the transceiver 12 includes a transistor TR1, a transistor TR2 and a driver 15. The transistor TR1 serves as a bus-driving transistor that connects/disconnects a path connecting between the bus CANH, i.e. one of the buses configuring the communication channel LN, and a power supply VCC. The transistor TR2 serves as a bus-driving transistor that connects/disconnects a path connecting between the bus CANL, i.e. the other of the buses configuring the communication channel LN, and a ground GND. The driver 15 simultaneously turns on/off the transistors TR1 and TR2 according to the signal level of transmission data TxD inputted from the CAN controller 14. The transistors TR1 and TR2 have respective connecting ends connected to the buses CANH and CANL, with respective diodes D1 and D2 being connected to protect the transistors TR1 and TR2.

The transceiver 12 also includes a receiver 16 configured by a first comparator CP1 and a second comparator CP2. The first comparator CP1 compares signal levels of the buses CANH and CANL (i.e. compares signal levels of the differential signals) and outputs the results of the comparison in the form of reception data RxD to be supplied to the CAN controller 14. The second comparator CP2 compares signal levels of the buses CANH and CANL and outputs the results of the comparison in the form of a reception signal Rsl. It should be appreciated that these comparators CP1 and CP2 each compare whether or not the difference (potential difference) between the signal levels of the buses CANH and CANL is equal to or more than a value specified in the specification (0.5 V in the present embodiment) and output the results of the comparison.

Further, the transceiver 12 includes an activation frame detector 17 and a wake-up controller 18. The activation frame detector 17 detects an activation frame specified in advance, based on the reception signal Rsl from the second comparator CP2 and outputs the wake-up signal WU or WA to the microcomputer 11. The wake-up controller 18 allows or inhibits power supply to the driver 15, the receiver 16 and the activation frame detector 17 in accordance with the stand-by signal STB obtained from the microcomputer 11 to control operation of these components.

Signal lines for the transmission data TxD and the stand-by signal STB are pulled up to the power supply VCC via resistors R1 and R2, respectively. Specifically, it is ensured that, when the ECU 10 has transitioned into a sleep mode and the microcomputer 11 has stopped, the transmission data TxD inputted to the transceiver 12 will be fixed to “1” and the stand-by signal STB will be fixed to an active level.

Also, it is ensured that, when the transistors TR1 and TR2 are in an off-state, the buses CANH and CANL will be in a state where no signal level difference is caused, i.e. in a recessive level, using respective known terminating transistors.

The driver 15 is adapted to turn off the transistors TR1 and TR2 when the transmission data TxD is “1” and turn on the transistors TR1 and TR2 when the transmission data TxD is “0”. In other words, the signal level of the differential signal in the communication channel LN turns to 0V (turns recessive) when the transmission data TxD is “1” and turns to 2V (turns dominant) when the transmission data TxD is “0”.

The first and second comparators CP1 and CP2 configuring the receiver 16 are configured such that either one of them is operated in accordance with an instruction from the wake-up controller 18. The first comparator CP1 is configured using an element which operates with high speed (consumes comparatively large electric power), so that the signal waveform of a differential signal is correctly reproduced. Meanwhile, the second comparator CP2 is configured using an element that consumes only a small amount of electric power.

The wake-up controller 18 allows power supply to the driver 15 and the first comparator CP1 of the receiver 16 when the stand-by signal STB shows a non-active level (when the operational mode is a normal mode) to activate the function of communicating with other ECUs 10 via the communication channel LN. At the same time, the wake-up controller 18 inhibits power supply to the second comparator CP2 of the receiver 16 and the activation frame detector 17 to deactivate the function of monitoring activation frame, by which an activation frame is detected.

On the other hand, the wake-up controller 18 inhibits power supply to the driver 15 and the first comparator CP1 of the receiver 16 when the stand-by signal STB shows an active level (when the operational mode is a sleep mode) to deactivate the function of communication. At the same time, the wake-up controller 18 allows power supply to the second comparator CP2 of the receiver 16 and the activation frame detector 17 to activate the function of monitoring activation frame.

FIG. 3B is a schematic diagram illustrating the activation frame detector 17. As shown in FIG. 3B, the activation frame detector 17 includes a stand-by state detection circuit 21, an activation pattern determination circuit 22 and a specific pattern determination circuit 23.

The stand-by state detection circuit 21 generates a stand-by state detection signal DTw that turns to a high level when the communication channel LN is in a stand-by state, based on the reception signal Rsl from the second comparator CP2. The activation pattern determination circuit 22 generates the random wake-up signal WA whose signal level turns to an active level when the stand-by state detection signal DTw turns from a high level to a low level, i.e. when the pattern set in the activation pattern area of a frame sent out to the communication channel LN indicates an activation ID. The specific pattern determination circuit 23 generates the specific wake-up signal WU whose signal level turns to an active level when the random wake-up signal WA turns active and the specific pattern set in the specific pattern area of a frame indicates the code assigned to the ECU in question. Hereinafter is specifically described a circuit configuration and operation of each of the components configuring the activation frame detector 17.

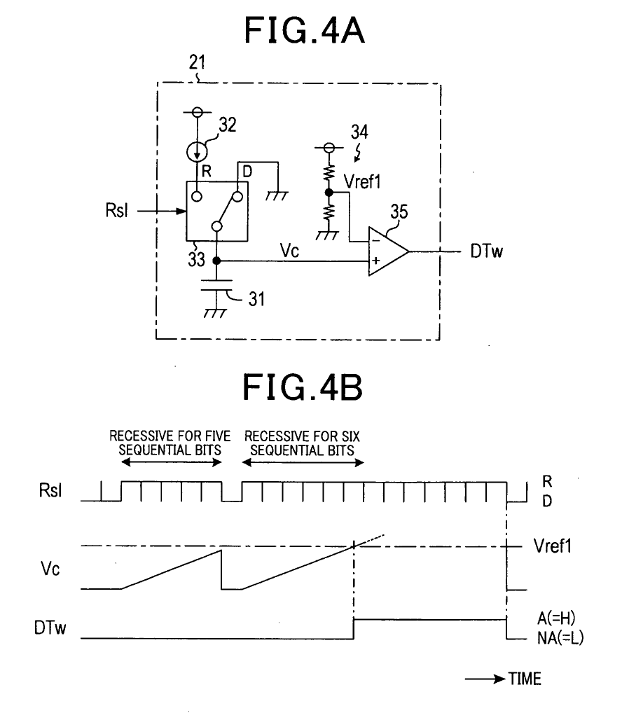

FIG. 4A is a circuit diagram specifically illustrating the stand-by state detection circuit 21. FIG. 4B is a timing diagram illustrating the operation of each of the components of the stand-by state detection circuit 21.

As shown in FIG. 4A, the stand-by state detection circuit 21 consists of a capacitor 31, a constant current source 32, a switch 33, a voltage divider circuit 34 and a comparator 35.

The capacitor 31, with its one end being grounded, is able to charge/discharge electric charge. The switch 33 connects a non-grounded end of the capacitor 31 to a ground level or to the constant current source 32 in accordance with the signal level of the reception signal Rsl. The voltage divider circuit 34 consists of a pair of resistors that divide voltage of the power supply VCC to generate a reference voltage (stand-by determination threshold) Vref1. The comparator 35 has an inverting input terminal to which the reference voltage Vref1 is applied and a non-inverting input terminal to which a voltage Vc of the non-grounded terminal of the capacitor 31 (hereinafter referred to “charging voltage Vc”) is applied. Thus, the stand-by state detection circuit 21 is configured to output the output of the comparator 35 in the form of the stand-by state detection signal DTw.

The switch 33 is ensured to establish connection with the ground when the reception signal Rsl is dominant, and with the constant current source 32 when recessive.

The current supplied by the constant current source 32, the capacity of the capacitor 31 and the level of the reference voltage Vref1 are set such that the charging voltage Vc will not reach the reference voltage Vref1 when the length of a period of continuously charging the capacitor 31 is not more than a period (or term) corresponding to five bits of a transmission code in the communication channel LN, and that the charging voltage Vc will exceed the reference voltage Vref1 when the length of the period becomes not less than a period corresponding to six bits of a transmission code.

As shown in FIG. 4B, in the stand-by state detection circuit 21 configured in this way, the charging voltage Vc is reset to 0V when the reception signal Rsl is dominant, for the increase of the charging voltage Vc at a constant rate while the reception signal Rsl is recessive.

When a recessive level continues for the number of consecutive bits of less than six and the charging voltage Vc is not more than the reference voltage Vref1, the stand-by state detection signal DTw shows a non-active level NA (=L) indicating that the state is not a stand-by state. On the other hand, when the a recessive level for the number of consecutive bits of not less than six and the charging voltage Vc exceeds the reference voltage Vref1, the stand-by state detection signal DTw, from this moment onwards up to a time point when the reception signal Rsl turns dominant, shows an active level A (=H) indicating that the state is a stand-by state.

The number of bits (six) serving as a reference for determining a stand-by state is set to a value larger than a maximum consecutive number of bits (five) of the same signal level, which is allowable in a frame (allowable consecutive number of bits). The allowable consecutive number of bits (five) is based on one of frame generation rules, i.e. a rule for inserting a stuff bit (a rule that, when signals of the same level continue for five bits, a stuff bit having an inverted signal level is inserted).

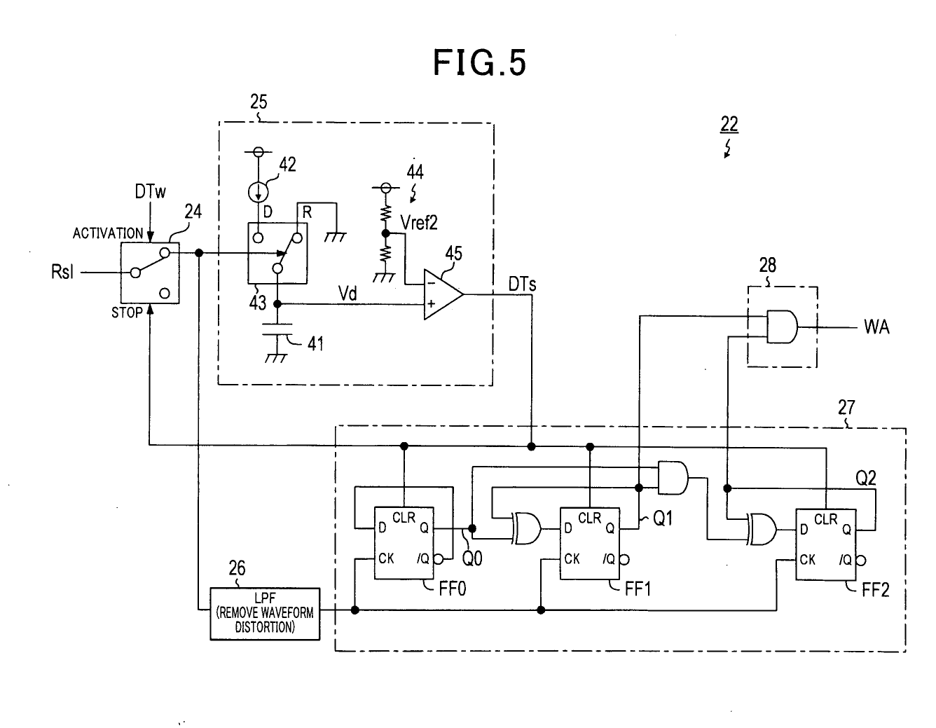

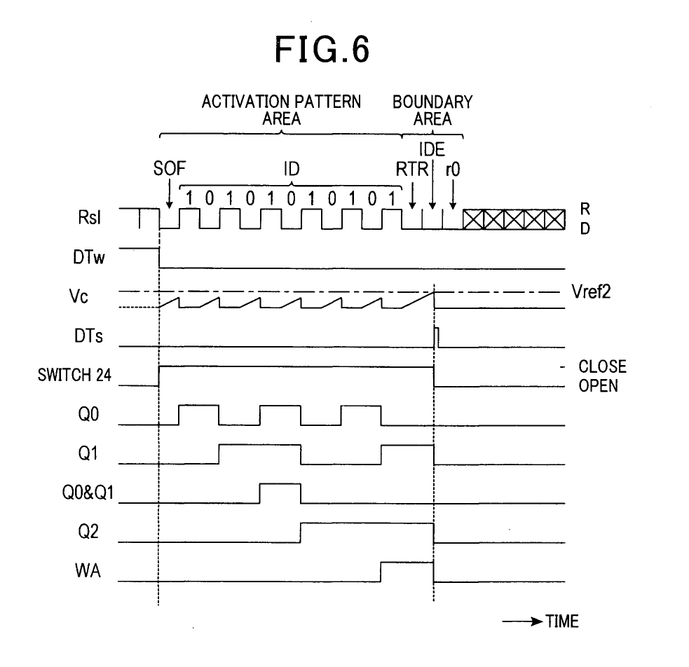

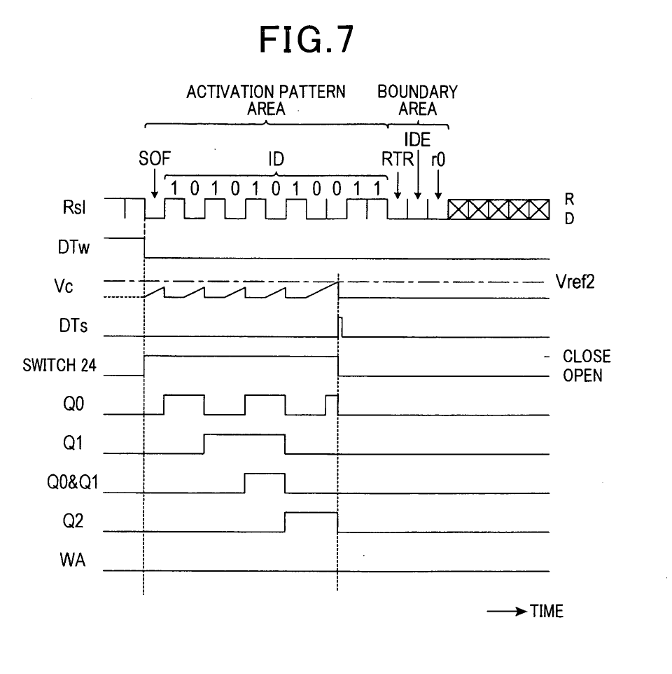

FIG. 5 is a circuit diagram specifically illustrating a configuration of the activation pattern determination circuit 22. FIGS. 6 and 7 are timing diagrams illustrating an operation of each of components of the activation pattern determination circuit 22.

As shown in FIG. 5, the activation pattern determination circuit 22 includes a switch 24, an end timing detection circuit 25, a low-pass filter 26, a counter circuit 27 and a determination circuit 28.

The switch 24, being provided in a path for supplying the reception signal Rsl, closes at the timing of a falling edge of the stand-by state detection signal DTw and opens at the timing of a rising edge of a termination signal which will be described later. The end timing detection circuit 25 generates a termination signal DTs that turns active upon detection of an area in which a dominant level continues for a period corresponding to two bits, or more, from the reception signal Rsl supplied via the switch 24. The low-pass filter 26 is provided for removing distortion of the reception signal Rsl supplied via the switch 24. The counter circuit 27 counts the number of count edges in the reception signals Rsl supplied via the low-pass filter 26 up until the timing of an edge at which the termination signal DTs turns from a non-active level to an active level. The determination circuit 28 generates the random wake-up signal WA that turns to an active level when the count of the counter circuit 27 coincides with a preset number of activations (six here).

The end timing detection circuit 25 consists of a capacitor 41, a constant current source 42, a switch 43, a voltage divider circuit 44 and a comparator 45.

The capacitor 41, with its one end being grounded, is able to charge/discharge electric charge. The switch 43 connects a non-grounded end of the capacitor 41 to a ground level or the constant current source 42 according to a signal level of the reception signal Rsl. The voltage divider circuit 44 consists of a pair of resistors that divide voltage of the power supply VCC and generates a reference voltage (termination determining threshold) Vref2. The comparator 45 has an inverting input terminal to which the reference voltage Vref2 is applied and a non-inverting input terminal to which a voltage Vd of the non-grounded end of the capacitor 41 (hereinafter referred to “charging voltage Vd”) is applied. Thus, the end timing detection circuit 25 is configured to output the output of the comparator 45 in the form of the termination signal DTs.

The switch 43 is ensured to establish connection with the ground level when the reception signal Rsl is recessive, and with the constant current source 42 when dominant.

The current supplied by the constant current source 42, the capacity of the capacitor 41 and the level of the reference voltage Vref2 are set such that the charging voltage Vd will not reach the reference voltage Vref2 when the length of a period of continuously charging the capacitor 41 is not more than a period corresponding to one bit of a transmission code in the communication channel LN, and that the charging voltage Vd will exceed the reference voltage Vref2 when the length of the period of becomes not less than a period corresponding to two bits of a transmission code.

The counter circuit 27 is made up of a known sync counter mainly configured by three D-type flip-flop circuits FF0, FF1 and FF2. The counter circuit 27 is connected such that resetting is released only for a period in which the termination signal DTs is at a non-active level and that the count-up operation is performed at the timing of a count edge of the reception signals Rsl (an edge that turns from a dominant level to a recessive level) supplied via the low-pass filter 26.

The determination circuit 28 inputs high-order bits (non-inverting outputs Q1 and Q2 of the flip-flop circuits FF1 and FF2, respectively) resulting from the counting of the counter circuit 27 and generates a logical product (AND gate) that generates the random wake-up signal WA that turns to a high level when both of the bits are at a high level.

As shown in FIGS. 6 and 7, in the activation pattern determination circuit 22 configured in this way, the supply of the reception signal Rsl via the switch 24 is started at a falling edge of the stand-by state detection signal DTw, i.e. at a timing when the head of a frame is detected, thereby starting a counting operation of the counter circuit 27. The counting operation is continued until the termination signal DTs turns to an active level.

When an activation ID is set in the activation pattern area (SOF and ID) of a frame sent out to the communication channel LN, signals of the same level will not occur for two consecutive bits, as shown in FIG. 6, in the activation pattern area, and thus the termination signal DTs remains at a non-active level. Accordingly, the count of the counter circuit 27 will be (Q0, Q1, Q2)=(0, 1, 1) indicating the number of activations of six, at a count edge that is a timing for starting the last bit of the activation pattern area. At this timing, the random wake-up signal WA turns to an active level.

After that, when the termination signal DTs turns to an active level in the boundary area (RTR, IDE and r0) where a dominant level continues for three consecutive bits, the counter circuit 27 is reset, allowing the random wake-up signal WA to again turn to a non-active level. At the same time, the switch 24 is opened to stop the supply of the reception signal Rsl, and thus the count of the counter circuit 27 is retained as at the time of being reset.

On the other hand, when an ID other than for activation is set in the activation pattern area of a frame sent out to the communication channel LN, the activation pattern area includes, as shown in FIG. 7, a part in which signals of the same level continues for two or more consecutive bits (FIG. 7 shows the case where a dominant level continues for two consecutive bits).

Then, at the time point when the activation pattern area has turned out to include a part in which a dominant level continues for two or more consecutive bits, the termination signal DTs turns to active to stop the counting operation of the counter circuit 27. As a result, the count of the counter circuit 27 is reset without reaching the number of activations and thus, the random wake-up signal WA is retained at a non-active level.

In the case where the activation pattern area does not include a part in which a dominant level continues, but includes a part in which a recessive level continues for two or more consecutive bits, the counter circuit 27 is operated until the termination signal DTs turns to an active level in the boundary area. However, as mentioned above, the count edges appear by the number of activations in an activation pattern area only when an activation ID is set in the activation pattern area. Therefore, in the above case, the count of the counter circuit 27 will not reach the number of activations, and thus the random wake-up signal WA is retained at a non-active level.

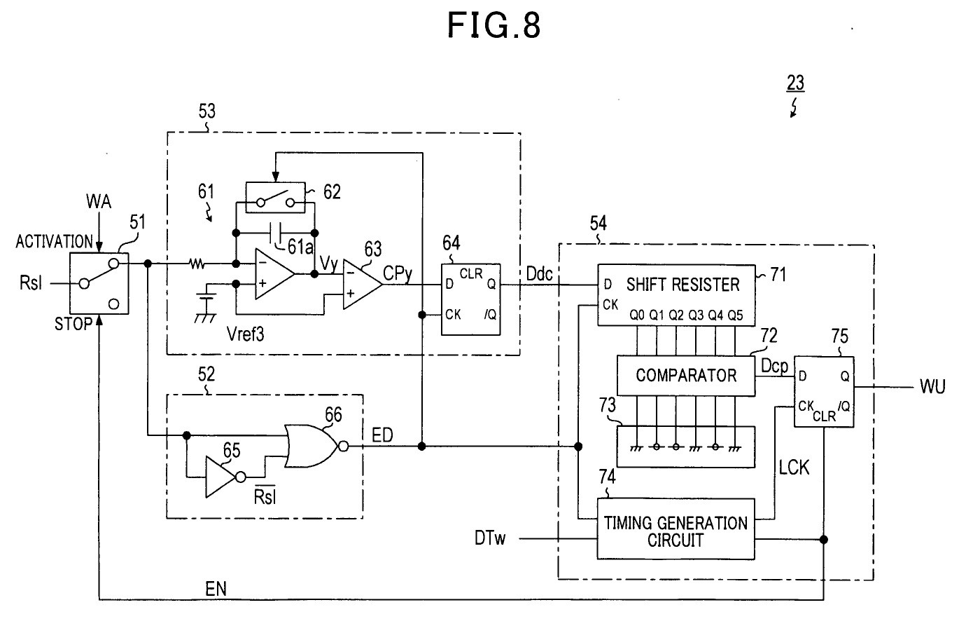

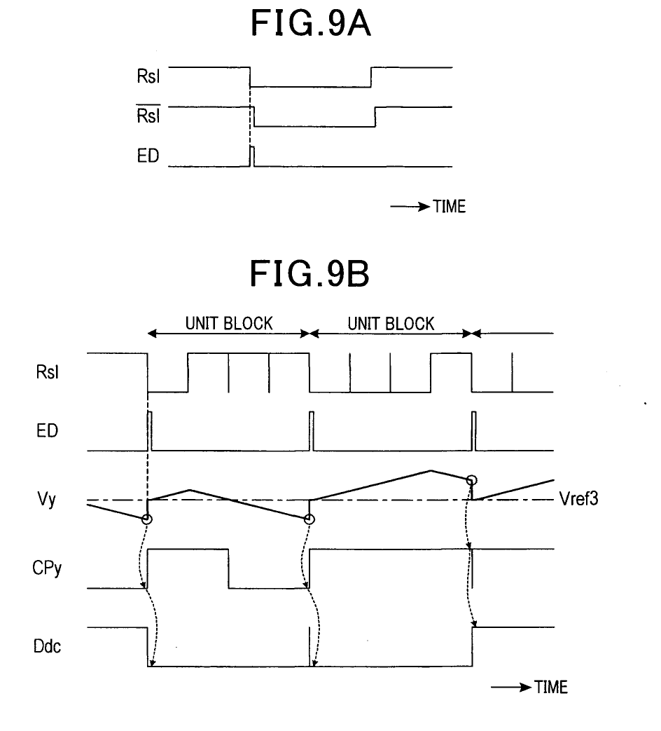

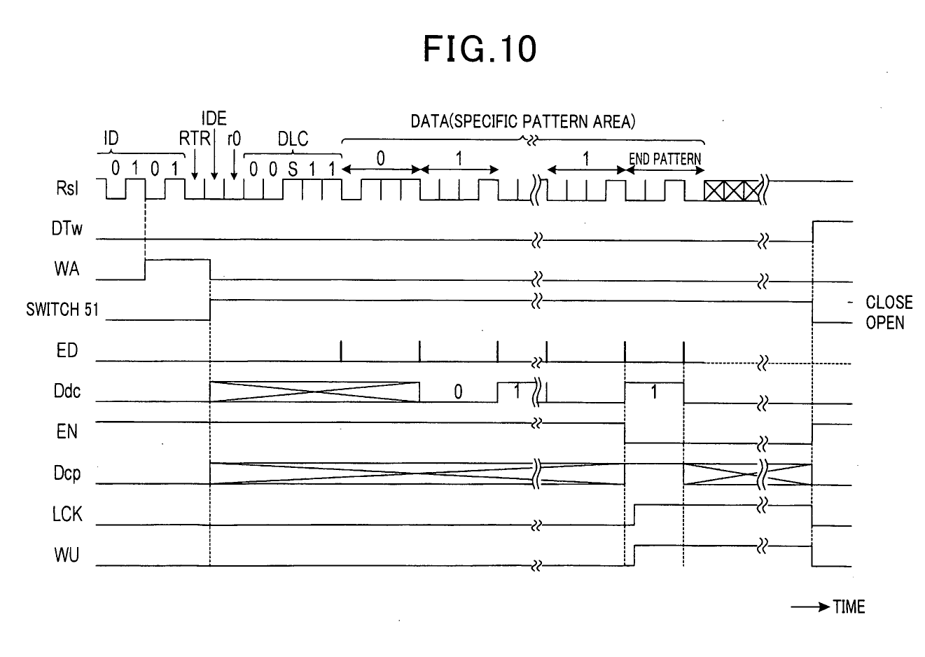

FIG. 8 is a circuit diagram specifically illustrating the configuration of the specific pattern determination circuit 23. FIGS. 9A and 9B as well as FIG. 10 are timing diagrams illustrating an operation of each of components of the specific pattern determination circuit 23.

As shown in FIG. 8, the specific pattern determination circuit 23 includes a switch 51, an edge detection circuit 52, a duty ratio decoder 53 and a data comparison circuit 54.

The switch 51 is provided at a path for supplying the reception signal Rsl. The switch 51 closes at a timing of an edge at which the random wake-up signal WA turns from a non-active level (low level) to an active level (high level) and opens at a timing of an edge at which an allowance signal EN, which will be described later, turns from an active level (low level) to a non-active level (high level). The edge detection circuit 52 generates an edge detection signal ED that indicates a timing of an edge of focus (edge at which a signal level turns from a recessive level to a dominant level) of the reception signal Rsl supplied via the switch 51. The duty ratio decoder 53 decodes the reception signal Rsl supplied via the switch 51 as a duty signal to produce decoded data Ddc. The data comparison circuit 54 generates the specific wake-up signal WU based on the edge detection signal ED and the decoded data Ddc. The specific wake-up signal WU turns to an active level when the decoded data Ddc coincides with an activation code assigned to the ECU in question.

Hereinafter is specifically described a circuit configuration and operation of each of the components configuring the specific pattern determination circuit 23.

The edge detection circuit 52 is made up of an inverting circuit (NOT gate) 65 and a NOR circuit (NOR gate) 66. The inverting circuit 65 inverts the level of the reception signal Rsl. The NOR circuit 66 inputs the output of the reception signal Rsl and the NOT gate 65, i.e. inputs an inverting signal of the reception signal Rsl. The output of the NOR circuit 66 turns to a high level when the output of both of the reception signal Rsl and the NOT gate 65 is at a low level. Thus, the edge detection circuit 52 outputs the output of the NOR gate 66 in the form of the edge detection signal ED.

As shown in FIG. 9A, the edge detection circuit 52 configured in this way outputs a pulse signal in the form of the edge detection signal ED at every timing of edge of focus of the reception signals Rsl, the pulse signal having a width corresponding to a delay time of the NOT gate 65.

Referring to FIG. 8 again, the duty ratio decoder 53 includes a known integrating circuit 61, a switch 62, a comparator 63 and a latch circuit 64.

The integrating circuit 61 is made up of an operational amplifier that has an inverting input terminal and an output terminal, with a capacitor 61a which is able to charge/discharge electric charge connected therebetween. The operational amplifier is connected such that a non-inverting input terminal of the operational amplifier is applied with a reference voltage (code determination threshold) Vref3 and the inverting input terminal is applied with the reception signal Rsl via a resistor.

The switch 62 short-circuits the capacitor 61a across the ends thereof when the level of the edge detection signal ED is high. The comparator 63 has an inverting input terminal to which an output Vy of the integrating circuit 61 is applied and a non-inverting input terminal to which the reference voltage Vref3 is applied. The latch circuit 64 consists of a D-type flip-flop and latches an output CPy of the comparator 63 at a timing of the edge detection signal ED. Thus, the duty ratio decoder 53 is configured to output the output of the latch circuit 64 in the form of the decoded data Ddc.

The reference voltage Vref3 is set to an intermediate value between a high level (recessive) VH and a low level (dominant) VL of the reception signal Rsl, i.e. set to a value as expressed by Vref3=(VH+VL)/2.

As shown in FIG. 9B, in the duty ratio decoder 53 configured in this way, the charging voltage (voltage on the side of an output terminal of the operational amplifier) Vy of the capacitor 61a, i.e. the output of the integrating circuit 61, is initialized to the reference voltage Vref3 every time an edge of focus is detected. Then, the charging voltage Vy increases at a constant rate while the level of the reception signal Rsl is low, and decreases at the same constant rate as at the time of increase when the level of the reception signal Rsl turns to a high level.

Specifically, at a period when edges of focus consecutively occur, if the level of the reception signals Rsl is high for a period longer than a period when the level of the reception signals Rsl is low, the charging voltage Vy becomes smaller than the reference voltage Vref3 at the end of the high-level period. On the other hand, when a low-level period is longer than a high-level period, the charging voltage Vy becomes larger than the reference voltage Vref3 at the end of the low-level period. In other words, the period when edges of focus consecutively occur is regarded as a single duty code, and depending on whether the duty ratio of the duty code is not less than 50%, the duty code is decoded into binary digital data.

Specifically, when the magnitude is the same between charge current having positive polarity and charge current having negative polarity, and when a duty ratio of a code pattern in a period (unit block) defined by edges of focus is 50%, the charge voltage of the third capacitive element at the end of the period coincides with the initial voltage. Thus, when the duty ratio is set to a value other than 50%, a determination of either “0” or “1” can be made, i.e. a duty signal can be decoded.

In the specific pattern area (i.e. data field) of an activation frame, it is ensured that an edge of focus is necessarily detected in each 4-bit unit block. Therefore, the bit pattern in the specific pattern area is decoded on a unit block basis by the duty ratio decoder 53.

Referring to FIG. 8 again, the data comparison circuit 54 includes a decoded data retention circuit 71, an assigned pattern setting circuit 73 and a comparator 72.

The decoded data retention circuit 71 is made up of a multi-stage shift register that inputs the decoded data Ddc for the operation using the edge detection signal ED as a shift clock. The assigned pattern setting circuit 73 is configured such as by a plurality of switches to set a signal level according to a pattern assigned to the ECU 10 in question. The comparator 72 generates a comparison data cp that turns to a high level when the decoded data retained in the decoded data retention circuit 71 coincides with the setting of the assigned pattern setting circuit 73.

The data comparison circuit 54 also includes a timing generation circuit 74 and a latch circuit 75.

The timing generation circuit 74 generates the allowance signal EN and a latch clock LCK based on the edge detection signal ED and the stand-by state detection signal DTw. The allowance signal EN indicates a timing of outputting the comparison data Dcp from the comparator 72, the comparison data Dcp indicating desired results of comparison. The latch clock LCK indicates a timing of latching the comparison data Dcp. The latch circuit 75 is made up of a D-type flip-flop circuit and has a resetting terminal to which the allowance signal EN is applied. The latch circuit 75 latches the comparison data Dcp from the comparator 72 at a timing of the latch clock LCK. Thus, the data comparison circuit 54 is configured to output a signal latched by the latch circuit 75 in the form of the specific wake-up signal WU.

The allowance signal EN is generated such that it turns to an active level (low level) at a timing that falls between the last unit block and a terminating pattern, thereby allowing the operation of the latch circuit 75, and that it turns to a non-active level (high level) at a timing when the stand-by state detection signal DTw turns from a non-active level to an active level, thereby inhibiting the operation of the latch circuit 75.

The latch clock LCK is generated such that it turns from a low level to a high level after the allowance signal EN has turned to a low level up until the timing of an edge of focus of a terminating pattern, and that it turns to a low level again at a timing when the stand-by state detection signal DTw turns from a non-active level to an active level.

The timing generation circuit 74 can be readily obtained by adequately combining a counter, a shift register, a latch circuit, a delay circuit, and the like. In obtaining the timing generation circuit 74, consideration is given to a period when the reception signals Rsl are supplied via the switch 51. That is, consideration is given to the number of edges of focus that occur when the random wake-up signal WA has turned to an active level (high level). The details for obtaining the timing generation circuit 74 are omitted here.

In the data comparison circuit 54 configured in this way, the decoded data Ddc corresponding to the results of decoding by the duty ratio decoder 53 is sequentially retained in the decoded data retention circuit 71. Then, the comparator 72 compares and determines whether the contents of the retained data coincide with the contents set in the assigned pattern setting circuit 73.

As shown in FIG. 10, all the decoded data Ddc is entirely retained in the decoded data retention circuit 71 from the timing of an edge of focus between the last unit block and a terminating pattern until the timing of the subsequent edge of focus. Thus, the comparison data Dcp indicating effectual results of comparison with the assigned pattern can be obtained. The comparison data Dcp is latched by the latch circuit 75 with the latch clock CLK that rises at the timing of obtaining the effectual results of comparison.

FIG. 10 shows the case where the specific code obtained by decoding the specific pattern set in a specific pattern area coincides with an assigned pattern. At the timing when the latch clock LCK rises, the comparison data Dcp turns to a signal level indicating coincidence (turns to a high level). Accordingly, at this timing, the specific wake-up signal WU that is the output of the latch circuit 75 turns to an active level. After that, at the timing when the stand-by state detection signal DTw turns to an active level, the specific wake-up signal WU again turns to a non-active level.

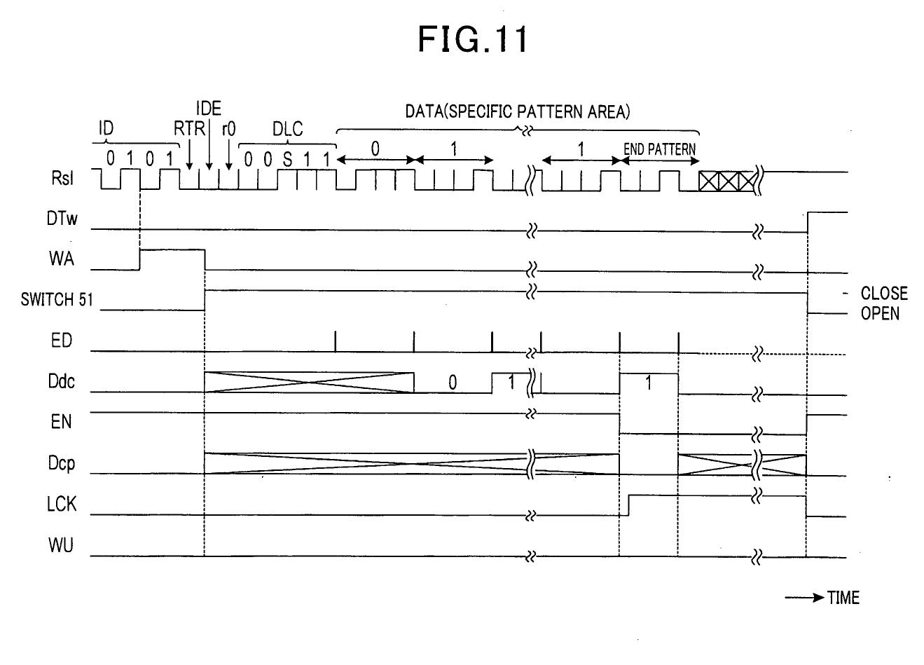

FIG. 11 shows the case where a specific code does not coincide with an assigned pattern. At the timing when the latch clock LCK rises, the comparison data Dcp turns to a signal level indicating non-coincidence (turns to a low level). Accordingly, the specific wake-up signal WU is retained at a non-active level.

As described above, in the communication system 1, the ECU 10 in a sleep mode is configured to monitor the communication channel LN and to recognize a frame as being an activation frame, in which the number of count edges in the activation pattern area coincides with the number of activations (to turn the random wake-up signal WA to an active level). In the above embodiment, a specific code is obtained by decoding a specific pattern which is regarded as a duty signal and set in the specific pattern area of the activation frame. The ECU 10 is configured to transition into a normal mode when the specific code indicated by the decoded data Ddc coincides with a pattern assigned in advance to the ECU 10 in question (to turn the specific wake-up signal WU to an active level).

Accordingly, according to the communication system 1, the CAN controller 14 and the clock circuit are not required to be operated for the determination regarding whether or not an activation frame has been received. Thus, power consumption of the ECU 10 in a sleep mode is reduced to a great extent.

Further, according to the communication system 1, not all the nodes that have received respective activation frames are unconditionally activated, but only those nodes which are specified in the activation frames are activated. Thus, those nodes which are not required to be activated will not be unnecessarily activated. As a result, power consumption of the entire communication system 1 is reduced.

In the present embodiment, the stand-by state detection circuit 21 corresponds to the activation timing detecting means. The end timing detection circuit 25 corresponds to the end timing detecting means. The counter circuit 27 and the determination circuit 28 correspond to the edge count determining means. The specific pattern determination circuit 23 corresponds to the code pattern determining means.

Further, in the stand-by state detection circuit 21, the capacitor 31 corresponds to the first capacitive element, and the constant current source 32 and the switch 33 correspond to the first charge circuit. In the end timing detection circuit 25, the capacitor 41 corresponds to the second capacitive element, the constant current source 42 and the switch 43 correspond to the second charge circuit. In the duty ratio decoder 53, the capacitor 61a corresponds to the third capacitive element, and the integrating circuit 61 corresponds to the third charge circuit.

Further, the CAN controller 14 corresponds to the communication control means. The wake-up process and the sleep process performed by the microcomputer 11, as well as the configuration for starting/stopping the clock circuit, which is a part of the microcomputer 11, correspond to the operational mode transitioning means.

### Modifications

An embodiment of the disclosure has been described so far.

However, the disclosure is not limited to the above embodiment but may be modified and implemented in various manners without departing from the spirit of the disclosure.

In the specific pattern determination circuit 23 of the above embodiment, the duty ratio decoder 53 regards a bit pattern of each unit block as a duty signal, the bit pattern being set to a specific pattern area. Then, the length of period is compared between two signal levels in a unit block to thereby decode the bit pattern without using clocks.

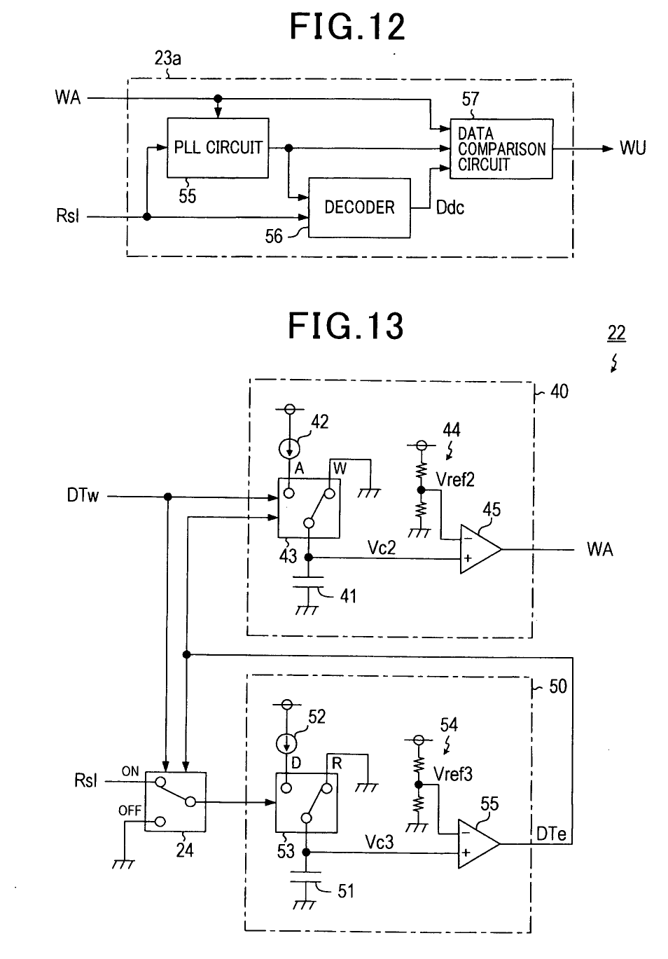

However, for example, as shown in a specific pattern determination circuit 23a of FIG. 12, a PLL circuit 55 that reproduces clock signals from the reception signals Rsl may be operated when an activation frame is recognized (when the random wake-up signal WA turns active). Then, a decoder 56 may decode the bit pattern in the data field according to the clocks generated by the PLL circuit 55.

In this case, a data comparison circuit 57 may generate the allowance signal EN and the latch clock LCK based on the clock generated by the PLL circuit 55, instead of the edge detection signal ED. Also, in this case, the bit pattern set in the specific pattern area of the activation frame may be set on a unit block basis, a unit block consisting of a plurality of bits. Specifically, the bit pattern may be one which can be decoded with clocks having lower accuracy than the clocks used in the CAN controller 14. The PLL circuit 55 here corresponds to the clock generation circuit of the disclosure. The decoder 56 corresponds to the decoder circuit of the disclosure.

In the above embodiment, the count edge counted by the activation pattern determination circuit 22 corresponds to an edge at which a dominant level turns to a recessive level. Alternative to this, an edge at which a recessive level turns to a dominant level may be used. Alternatively, both of the turning edges may be used.

In the above embodiment, a stand-by state is determined when a dominant level continues for six or more consecutive bits. However, this may not impose a limitation. For example, the consecutive bits may be N+1 bits or more but may be 11 bits or less, where N is a maximum number of consecutive bits of the same level allowable in a frame with an insertion of stuff bits. It should be appreciated that the 11 bits correspond to the sum of the ACK delimiter (1 bit), the EOF (7 bits) and the intermission (3 bits) inserted between frames.

In the above embodiment, the stand-by state detection circuit 21 and the end timing detection circuit 25 having the same circuit configuration are separately provided. Alternative to this, these circuits may be configured as a single circuit. In this case, however, it is required to be so configured that circuit constants (e.g., reference voltage, constant current, and relationship between a signal level and a connection destination of a switch) are switched depending on whether the circuit is used as the stand-by state detection circuit 21 or as the end timing detection switch 25.

### Second Embodiment

Referring to FIGS. 13-19, a second embodiment of the present invention will now be described.

It should be appreciated that in the second and subsequent embodiments, the component identical with or similar to those in the first embodiment are given the same reference numerals for the sake of omitting unnecessary explanation. In addition, the explanation in the second and subsequent embodiments will be done mainly for parts different from those in the first embodiment.

The second embodiment is different from the first embodiment only in the ID used for activation and a part of the configuration of the activation pattern determination circuit 22. The description set forth below is given focusing on the differences.

A portion (SOF and ID) of the activation pattern area of an activation frame is expressed by <0>11111(0)11111(0)1, where <0> indicates SOF and (0) indicates a stuff bit. Thus, when ID=0x7FF is established, with a boundary condition being that an area having two or more consecutive dominant bits firstly appears in a frame, the length of the bits up to a point satisfying the boundary condition (this point is also referred to as a “boundary point”) is maximized (14 bits), forming a sole unique bit pattern. Specifically, two consecutive dominant bits firstly appear at RTR and IDE, and thus the length of the preceding SOF and ID amounts to 14 bits including stuff bits.

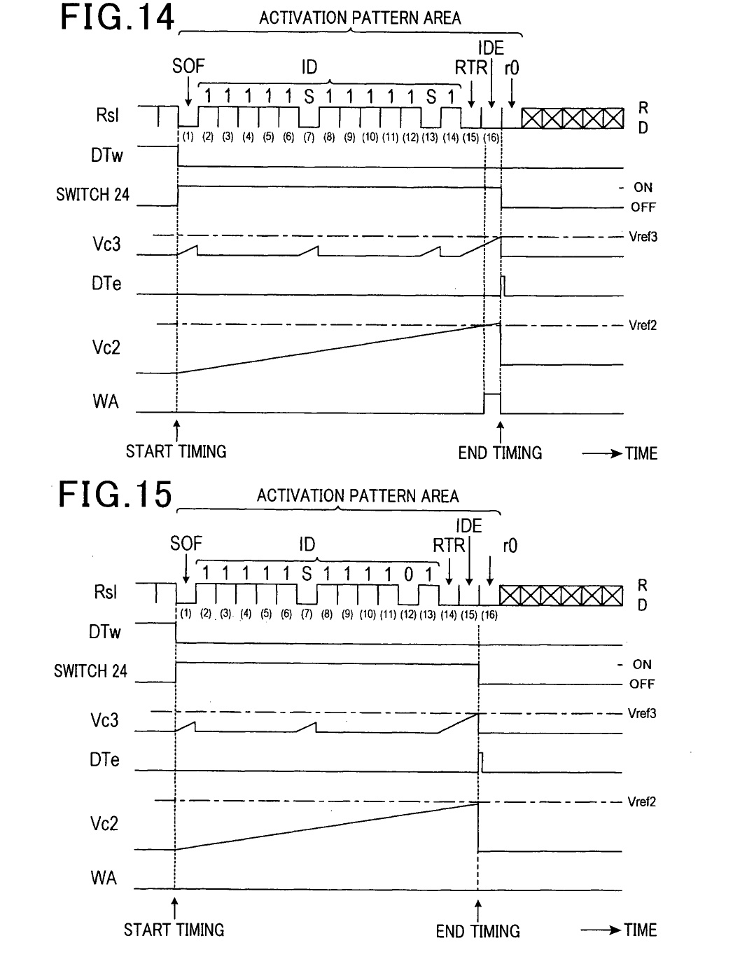

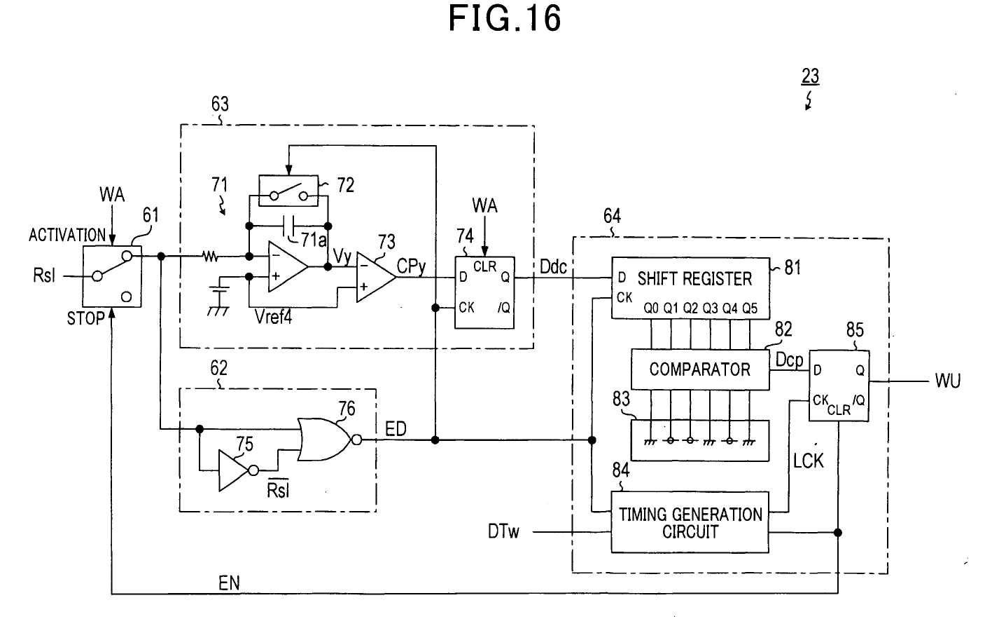

FIG. 13 is a circuit diagram specifically illustrating the configuration of the activation pattern determination circuit 22. FIGS. 14 and 15 are timing diagrams illustrating an operation of the components of the activation pattern determination circuit 22. The bracketed numerals in FIGS. 14 and 15 indicate the order of the bit from the head of the frame.

As shown in FIG. 13, the activation pattern determination circuit 22 includes a switch 24, an end timing detection circuit 50 and a period-length determination circuit 40.

The switch 24 is provided in the path for supplying the reception signal Rsl. The switch 24 turns to an on-state at a timing of a falling edge of the stand-up state detection signal DTw (hereinafter referred to as “start timing”), i.e. at a timing of starting reception of a frame. The switch 24 turns to an off-state (state of supplying ground potential to an output side) at the timing of a rising edge of a termination signal DTe (hereinafter referred to as “end timing”) described later. The end timing detection circuit 50 generates the termination signal DTe that turns to an active level (high level) upon detection of an area in which a dominant level continues for a period corresponding to two bits of a transmission code, from the reception signal Rsl supplied via the switch 24. The period-length determination circuit 40 generates the random wake-up signal WA that turns to an active level (high level) up until the end timing, when the time from the start timing expires a period corresponding to a preset activation period length before the expiration of the end timing.

The end timing detection circuit 50 includes a capacitor 51, a constant current source 52, a switch 53, a voltage divider circuit 54 and a comparator 55.

The capacitor 51, with its one end being grounded, is able to charge/discharge electric charge. The switch 53 connects a non-grounded end of the capacitor 51 to a ground level or the constant current source 52 according to a signal level of the reception signal Rsl. The voltage divider circuit 54 consists of a pair of resistors that divide a power source voltage VCC and generates the reference voltage (termination determining threshold) Vref3. The comparator 55 has an inverting input terminal to which the reference voltage Vref3 is applied and a non-inverting input terminal to which the voltage of the non-grounded end of the capacitor 51 (hereinafter referred to as “charging voltage”) Vc3. Thus, the end timing detection circuit 50 is configured to output the output of the comparator in the form of the termination signal DTe.

The switch 53 is ensured to be connected to the ground level when the reception signal Rsl is recessive and to the constant current source 52 when dominant.

The current supplied by the constant current source 52, the capacity of the capacitor 51 and the reference voltage Vref3 are set such that the charging voltage Vc3 will not reach the reference voltage Vref3 when the length of a period for continuously charging the capacitor 51 is not more than a period corresponding to one bit of a transmission code, and that the charging voltage Vc3 will exceed the reference voltage Vref3 when the length of the period exceeds the period (a length corresponding to two bits or so in the present embodiment).

The period-length determination circuit 40 includes a capacitor 41, a constant current source 42, a switch 43, a voltage divider circuit 44 and a comparator 45.

The capacitor 41, with its one end being grounded, is able to charge/discharge electric charge. The switch 43 connects a non-grounded end of the capacitor 41 to a ground level or to the constant current source 42 according to the stand-by state detection signal DTw and the termination signal DTe. The voltage divider circuit 44 consists of a pair of resistors that divide the power supply voltage VCC and generates the reference voltage (period determination threshold) Vref2. The comparator 45 has an inverting input terminal to which the reference voltage Vref2 is applied and a non-inverting input terminal to which the voltage of the non-grounded end of a capacitor 41 (hereinafter referred to as “charging voltage”) Vc2 is applied. Thus, the period-length determination circuit 40 is configured to output the output of the comparator 45 in the form of the random wake-up signal WA.

The switch 43 is ensured to be switched to the constant current source 42 at the timing of a falling edge of the stand-by state detection signal DTw, i.e. at the start timing, and to be switched to the ground level at the timing of a rising edge of the termination signal DTe, i.e. at the end timing.

The current supplied by the constant current source 42, the capacity of the capacitor 41 and the reference voltage Vref2 are set such that the charging voltage Vc2 will not reach the reference voltage Vref2 when the length of a period for continuously charging the capacitor 41 is not more than a period corresponding to 15 bits of a transmission code, and that the charging voltage Vc2 will exceed the reference voltage Vref2 when the length of the period exceeds the period (i.e. a length reaching the 16^{th} bit).

Specifically, the period corresponding to the reference voltage Vref2 is an activation period length. The activation period length is set so as to correspond to the length of an area from the head of a frame to a point slightly over a boundary between the 15^{th} and the 16^{th} bits (at least a point nearer to the head with reference to the center position between the bits).

As shown in FIGS. 14 and 15, in the activation pattern determination circuit 22 configured in this way, the end timing detection circuit 50 and the period-length determination circuit 40 start operation at the falling edge of the stand-by state detection signal Dtw, i.e. at the start timing.

When an activation ID (=0x7 FF) is set in the activation pattern area of a frame sent out to the communication channel LN, a dominant level will not continue, as shown in FIG. 14, for two consecutive bits in the periods of SOF and ID in the activation pattern area. Accordingly, the charging voltage Vc3 will not exceed the reference voltage Vref3 in the end timing detection circuit 50. The periods of RTR, IDE and r0 following ID are ensured to be dominant, and thus the charging voltage Vc3 becomes large exceeding the reference voltage Vref3 in the vicinity of the boundary between IDE (16^{th} bit from the head) and r0 (17^{th} bit from the head) to thereby turn the termination signal DTe to an active level.

Then, the state of the switch 24 is switched and thus the state of the switch 53 is switched. Accordingly, the charging voltage Vc3 is reset to 0V that is an initial voltage, and thus the termination signal DT3 again turns to a non-active level.

In this case, in the period-length determination circuit 40, the charging voltage Vc2 keeps increasing at a constant rate from the start timing and exceeds the reference voltage Vref2 at a time point when a period from the start timing has slightly exceeded a period defined by a point as a boundary between the 15^{th} and the 16^{th} bits. Thus, the random wake-up signal WA turns to an active level, and then the state of the switch 43 is switched at the timing when the termination signal DTe turns to an active level. Thus, the charging voltage Vc2 is reset to 0V that is an initial voltage to allow the random wake-up signal WA to again turn to a non-active level.

On the other hand, data other than the activation ID may be set in the activation pattern area of a frame sent out to the communication channel LN. In the case where two stuff bits other than the activation ID are inserted, the case is limited to ID=0x7FE. In other cases, the number of stuff bits inserted in the period of ID is one bit or less.

In the former case, the maximum of the periods of SOF and ID will be 13 bits. FIG. 15 shows an example of the case of ID=0x7FD.

In this case, a dominant level will not continue for two consecutive bits in the periods of SOF and ID in the activation pattern area. Accordingly, in the end timing detection circuit 50, the charging voltage Vc3 becomes large exceeding the reference voltage Vref3 in the vicinity of the boundary between IDE (15^{th} bit from the head) and r0 (16^{th} bit from the head) to thereby turn the termination signal DTe to an active level.

In other words, the period from the start timing to the end timing is shorter than the activation period length (length reaching the 16^{th} bit). Accordingly, the charging voltage Vc2 of the period length determination circuit 40 will not reach the reference voltage Vref3 but will be reset to 0V, an initial voltage, while the random wake-up signal WA is retained at a non-active level without turning to an active level.

In the latter (ID=7EF) case, the periods of SOF and ID correspond to 14 bits, while the last bit of ID is dominant. Accordingly, in the end timing detection circuit 50, the charging voltage Vc3 becomes large exceeding the reference voltage Vref3 in the vicinity of the boundary between RTR (15^{th} bit from the head) and IDE (16^{th} bit from the head) to thereby turn the termination signal DTe to an active level. As a result, the period-length determination circuit 40 operates similar to the former case mentioned above.

As a matter of course, in the cases, as well, where the number of inserted stuff bits is “0” or where an activation pattern area includes a part in which a dominant level continues for two or more consecutive bits, the period from the start timing to the end timing is shorter than the activation period length (length reaching the 16^{th} bit). Thus, the random wake-up signal WA will not turn to an active level.

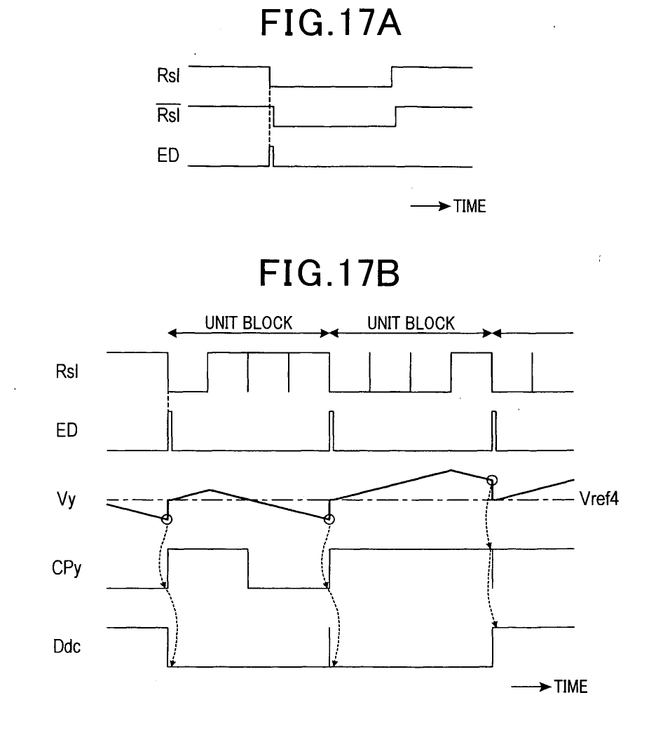

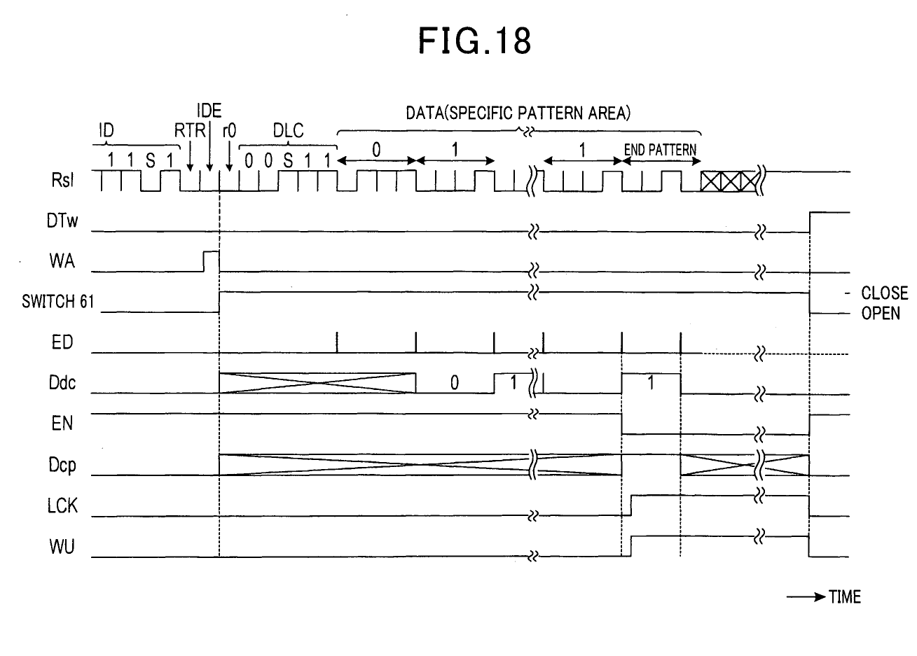

FIG. 16 is a circuit diagram specifically illustrating a configuration of the specific pattern determination circuit 23. FIGS. 17A and 17B as well as FIG. 18 are timing diagrams illustrating an operation of each of components of the specific pattern determination circuit 23.

As shown in FIG. 16, the specific pattern determination circuit 23 includes a switch 61, an edge detection circuit 62, a duty ratio decoder 63 and a data comparison circuit 64.

The switch 61 is provided at a path for supplying the reception signal Rsl. The switch 61 closes at a timing of an edge at which the random wake-up signal WA turns from a non-active level (low level) to an active level (high level) and opens at a timing of an edge at which an allowance signal EN, which will be described later, turns from an active level (low level) to a non-active level (high level). The edge detection circuit 62 generates an edge detection signal ED that indicates a timing of an edge of focus (edge at which a signal level turns from a recessive level to a dominant level) of the reception signal Rsl supplied via the switch 61. The duty ratio decoder 63 decodes the reception signal Rsl supplied via the switch 61 as a duty signal to produce decoded data Ddc. The data comparison circuit 64 generates the specific wake-up signal WU based on the edge detection signal ED and the decoded data Ddc. The specific wake-up signal WU turns to an active level when the decoded data Ddc matches an activation code assigned to the ECU in question.

Hereinafter is specifically described a circuit configuration and operation of each of the components configuring the specific pattern determination circuit 23.

The edge detection circuit 62 consists of an inverting circuit (NOT gate) 75 and a NOR circuit (NOR gate) 76. The inverting circuit 75 inverts the level of the reception signal Rsl. The NOR circuit 76 inputs the output of the reception signal Rsl and the NOT gate 75, i.e. inputs an inverting signal of the reception signal Rsl. The output of the NOR circuit 76 turns to a high level when the output of both of the reception signal Rsl and the NOT gate 65 is at a low level. Thus, the edge detection circuit 62 outputs the output of the NOR gate 76 in the form of the edge detection signal ED.

As shown in FIG. 17A, the edge detection circuit 62 configured in this way outputs a pulse signal in the form of the edge detection signal ED at every timing of edge of focus of the reception signals Rsl, the pulse signal having a width corresponding to a delay time of the NOT gate 75.

Referring to FIG. 16 again, the duty ratio decoder 63 includes a known integrating circuit 71, a switch 72, a comparator 73 and a latch circuit 74.

The integrating circuit 71 is made up of an operational amplifier that has an inverting input terminal and an output terminal, with a capacitor 71a which is able to charge/discharge electric charge connected therebetween. The operational amplifier is connected such that a non-inverting input terminal of the operational amplifier, is applied with a reference voltage (code determination threshold) Vref4 and the inverting input terminal is applied with the reception signal Rsl via a resistor.

The switch 72 short-circuits the capacitor 71a across the ends thereof when the level of the edge detection signal ED is high. The comparator 73 has an inverting input terminal to which an output Vy of the integrating circuit 71 is applied and a non-inverting input terminal to which the reference voltage Vref4 is applied. The latch circuit 74 consists of a D-type flip-flop and latches an output CPy of the comparator 73 at a timing of the edge detection signal ED. Thus, the duty ratio decoder 63 is configured to output the output of the latch circuit 74 in the form of the decoded data Ddc.

The reference voltage Vref4 is set to an intermediate value between a high level (recessive) VH and a low level (dominant) VL of the reception signal Rsl, i.e. set to a value as expressed by Vref4=(VH+VL)/2.

As shown in FIG. 17B, in the duty ratio decoder 63 configured in this way, the charging voltage (voltage on the side of an output terminal of the operational amplifier) Vy of the capacitor 71a, i.e. the output of the integrating circuit 71, is initialized to the reference voltage Vref4 every time an edge of focus is detected. Then, the charging voltage Vy increases at a constant rate (i.e. charged with a charging current having positive polarity) while the level of the reception signal Rsl is low, and decreases at the same constant rate as at the time of increase (i.e. charged with a charging current having negative polarity), when the level of the reception signal Rsl turns to a high level.

Specifically, in a period when edges of focus consecutively occur, if the level of the reception signals Rsl is high for a period longer than a period when the level of the reception signals Rsl is low, the charging voltage Vy becomes smaller than the reference voltage Vref4 at the end of the high-level period. On the other hand, when a low-level period is longer than a high-level period, the charging voltage Vy becomes larger than the reference voltage Vref4 at the end of the low-level period. In other words, the period when edges of focus consecutively occur is regarded as a single duty code, and depending on whether the duty ratio of the duty code is not less than 50%, the duty code is decoded into binary digital data.

In the specific pattern area (i.e. data field) of an activation frame, it is ensured that an edge of focus is necessarily detected in each 4-bit unit block. For this reason, bit patterns in the specific pattern area are decoded on a unit block basis by the duty ratio decoder 63.

Referring to FIG. 16 again, the data comparison circuit 64 includes a decoded data retention circuit 81, an assigned pattern setting circuit 83 and a comparator 82.

The decoded data retention circuit 81 is made up of a multi-stage to shift register that inputs the decoded data Ddc for the operation using the edge detection signal ED as a shift clock. The assigned pattern setting circuit 83 is configured such as by a plurality of switches to set a signal level according to a pattern assigned to the ECU 10 in question. The comparator 82 generates a comparison data cp that turns to a high level when the decoded data retained in the decoded data retention circuit 81 matches the setting of the assigned pattern setting circuit 83.

The data comparison circuit 64 also includes a timing generation circuit 84 and a latch circuit 85.

The timing generation circuit 84 generates the allowance signal EN and a latch clock LCK based on the edge detection signal ED and the stand-by state detection signal DTw. The allowance signal EN indicates a timing of outputting the comparison data Dcp from the comparator 82, the comparison data Dcp indicating desired results of comparison. The latch clock LCK indicates a timing of latching the comparison data Dcp. The latch circuit 85 is made up of a D-type flip-flop circuit and has a resetting terminal to which the allowance signal EN is applied. The latch circuit 85 latches the comparison data Dcp from the comparator 82 at a timing of the latch clock LCK. Thus, the data comparison circuit 64 is configured to output a signal latched by the latch circuit 85 in the form of the specific wake-up signal WU.

The allowance signal EN is generated such that it turns to an active level (low level) at a timing that falls between the last unit block and a terminating pattern, thereby allowing the operation of the latch circuit 85, and that it turns to a non-active level (high level) at a timing when the stand-by state detection signal DTw turns from a non-active level to an active level, thereby inhibiting the operation of the latch circuit 85.

The latch clock LCK is generated such that it turns from a low level to a high level after the allowance signal EN has turned to a low level up until the timing of an edge of focus of a terminating pattern, and that it turns to a low level again at a timing when the stand-by state detection signal DTw turns from a non-active level to an active level.

The timing generation circuit 84 can be readily obtained by adequately combining a counter, a shift register, a latch circuit, a delay circuit, and the like. In obtaining the timing generation circuit 84, consideration is given to a period when the reception signals Rsl are supplied via the switch 61. That is, consideration is given to the number of edges of focus that occur when the random wake-up signal WA has turned to an active level (high level). The details for obtaining the timing generation circuit 84 are omitted here.

In the data comparison circuit 64 configured in this way, the decoded data Ddc corresponding to the results of decoding by the duty ratio decoder 63 is sequentially retained in the decoded data retention circuit 81. Then, the comparator 82 compares and determines whether the contents of the retained data match the contents set in the assigned pattern setting circuit 83.

As shown in FIG. 18, all the decoded data Ddc is entirely retained in the decoded data retention circuit 81 from the timing of an edge of focus between the last unit block and a terminating pattern until the timing of the subsequent edge of focus. Thus, the comparison data Dcp indicating effectual results of comparison with the assigned pattern can be obtained. The comparison data Dcp is latched by the latch circuit 85 with the latch clock CLK that rises at the timing of obtaining the effectual results of comparison.

FIG. 18 shows the case where the specific code obtained by decoding the specific pattern set in a specific pattern area matches an assigned pattern. At the timing when the latch clock LCK rises, the comparison data Dcp turns to a signal level indicating match (turns to a high level). Accordingly, at this timing, the specific wake-up signal WU that is the output of the latch circuit 85 turns to an active level. After that, at the timing when the stand-by state detection signal DTw turns to an active level, the specific wake-up signal WU again turns to a non-active level.

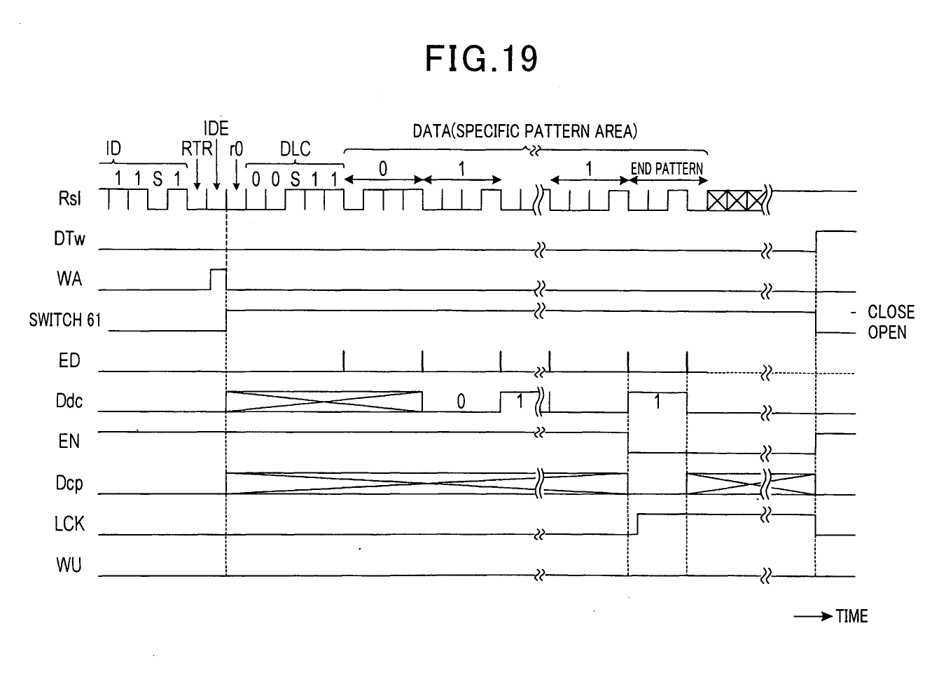

FIG. 19 shows the case where a specific does not match an assigned pattern. At the timing when the latch clock LCK rises, the comparison data Dcp turns to a signal level indicating non-match (turns to a low level). Accordingly, the specific wake-up signal WU is retained at a non-active level.

As described above, in the communication system 1, the ECU 10 in a sleep mode is configured to monitor the communication channel LN, and to recognize a frame whose area length from the head (start timing) of the frame to a part where a dominant level continues for two consecutive bits (end timing) is longer than an activation period length (allow the random wake-up signal WA to turn to an active level). In the above embodiment, a specific code is obtained by decoding a specific pattern which is regarded as a duty signal and set in the specific pattern area of the activation frame. The ECU 10 is configured to transition into a normal mode when the specific code indicated by the decoded data Ddc matches a pattern assigned in advance to the ECU 10 (to turn the specific wake-up signal WU to an active level).

Accordingly, according to the communication system 1, the CAN controller 14 and the clock circuit are not required to be operated for the determination regarding whether or not an activation frame has been received. Thus, power consumption of the ECU 10 in a sleep mode is reduced to a great extent.

Further, according to the communication system 1, not all the nodes that have received respective activation frames are unconditionally activated, but only those nodes which are specified in the activation frames are activated. Thus, those nodes which are not required to be activated will not be unnecessarily activated. As a result, power consumption of the entire communication system 1 is reduced.

In the present embodiment, the stand-by state detection circuit 21 corresponds to the activation timing detecting means. The end timing detection circuit 50 corresponds to the end timing detecting means. The period-length determination circuit 40 corresponds to the period-length determining means. The specific pattern determination circuit 23 corresponds to the code pattern determining means.

Also, in the end timing detection circuit 50, the capacitor 51 corresponds to the first capacitive element, and the constant current source 52 and the switch 53 correspond to the first charge circuit. In the period-length determination circuit 40, the capacitor 41 corresponds to the second capacitive element, and the constant current source 42 and the switch 43 correspond to the second charge circuit. In the stand-by state detection circuit 21, the capacitor 31 corresponds to the third capacitive element, and the constant current source 32 and the switch 33 correspond to the third charge circuit. In the duty ratio decoder 63, the capacitor 71a corresponds to the fourth capacitive element and the integrating circuit 71 corresponds to the fourth charge circuit.

Further, the CAN controller 14 corresponds to the communication control means. The wake-up process and the sleep process performed by the microcomputer 11, as well as the configuration for starting/stopping the clock circuit, which is a part of the microcomputer 11, correspond to the operational mode transitioning means.

### Third Embodiment

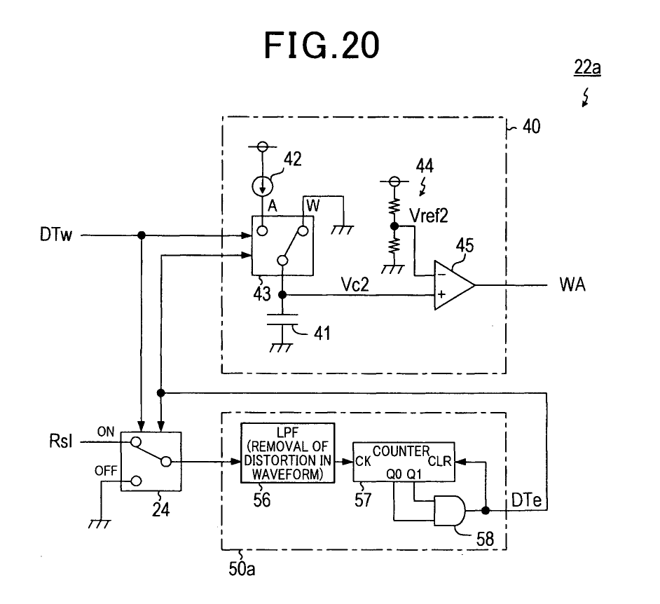

With reference to FIGS. 20-23, hereinafter is described a third embodiment of the invention.

The present embodiment uses a data frame as an activation frame in which ID is set to 0x078. In other words, use of this ID is inhibited in the communication between the ECUs 10 whose operational mode is a normal mode.

The activation pattern area of the activation frame is expressed with bit patterns as: [0][0000(1)1111(0)00][0(1)00]. The first square brackets indicate SOF, the second square brackets indicate ID and the third square brackets indicate RTR, IDE and R0. Also, (0) and (1) indicate stuff bits.

This ID (=0x078) is a sole unique bit pattern in which each edge at which a receptive level turns to a dominant level is used as an edge of focus, and a bit length from the head (start timing) to the third edge of focus (end timing) is maximized (16 bits). From a different point of view, this ID is a sole unique bit pattern in which the number of edges of focus detected in the activation pattern area corresponds to a minimum K (K=3) number of boundaries.

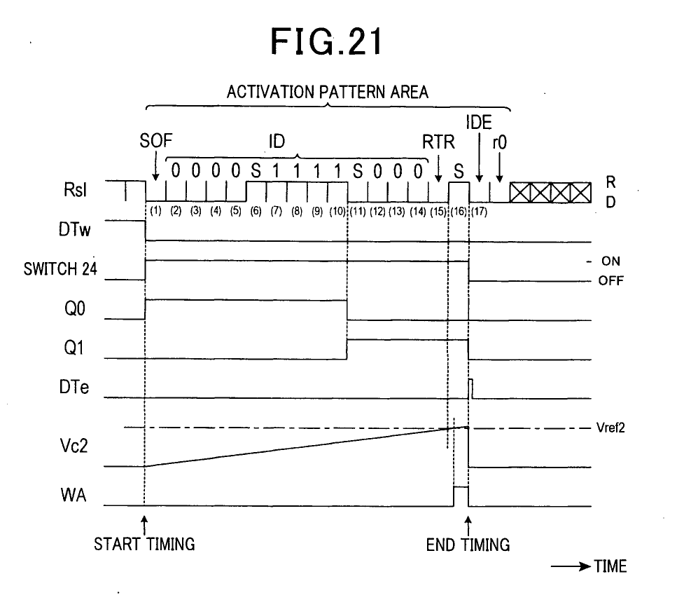

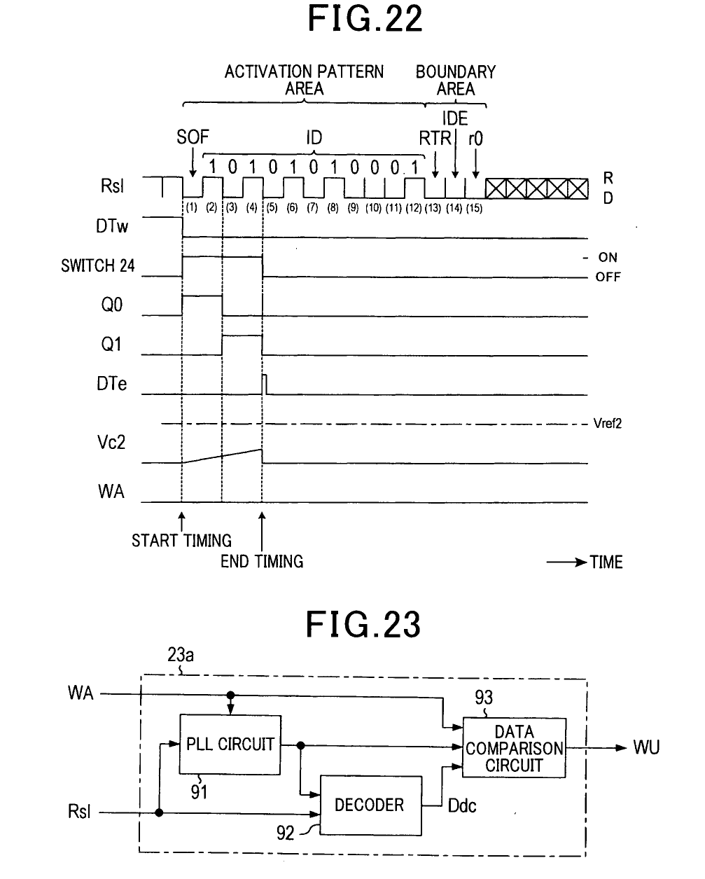

FIG. 20 is a circuit diagram illustrating a configuration of an activation pattern determination circuit 22a. FIGS. 21 and 22 are timing diagrams illustrating an operation of each of components in the activation pattern determination circuit 22a. The bracketed numerals in FIGS. 21 and 22 indicate the order of the bit from the head of the frame.

As shown in FIG. 20, the activation pattern determination circuit 22a includes the switch 24, an end timing detection circuit 50a and the period-length determination circuit 40. Thus, only the end timing detection circuit 50a is different from that of the second embodiment.

However, in the period-length determination circuit 40, the current supplied by the constant current source 42, the capacity of the capacitor 41 and the reference voltage Vref2 are set such that the charging voltage Vc2 will not reach the reference voltage Vref2 when the length of a period for continuously charging the capacitor 41 is not more than a length of a period corresponding to 15 bits of a transmission code, and that the charging voltage Vc2 will exceed the reference voltage Vref2 when the length of the period exceeds the period (i.e., when the period has a length reaching the 16^{th} bit).

The end timing detection circuit 50a includes a low-pass filter 56, a sync counter 57 and an AND circuit (AND gate) 58.

The low-pass filter 56 is provided for removing distortion of the reception signal Rsl supplied via the switch 24. The sync counter 57 inputs, as clocks, the reception signals Rsl supplied via the low-pass filter 56 to count the number of edges in the reception signals Rsl. The AND circuit 58 inputs a first digit Q0 and a second digit Q1 outputted from the counter 57 to generate the termination signal DTe when both of the digits are at a high level (active level), i.e. when the count has become equal to K (=3), the number of boundaries. The counter 57 is connected such that the count is cleared when the termination signal DT3 is at an active level.

As shown in FIGS. 21 and 22, in the activation pattern determination circuit 22a configured in this way, the end timing detection circuit 50 and the period-length determination circuit 40 start operation with a falling edge of the stand-by state detection signal DTw, i.e. starts operation at the start timing.

When an activation ID (=0x078) is set in the activation pattern area of the frame sent out to the communication channel LN, a first edge of focus occurs, as shown in FIG. 21, at the start timing. A second edge of focus occurs at a boundary between the 10^{th} bit and the 11^{th} bit from the head. A third edge of focus occurs at a boundary between the 16^{th} bit (stuff bit inserted after RTR) and the 17^{th} bit (IDE) from the head. In other words, the termination terminal DT3 turns to an active level at a timing of the boundary between the 16^{th} and 17^{th} bits from the head, and this timing corresponds to the end timing.

The charging voltage Vc2 of the period-length determination circuit 40 exceeds the reference voltage Vref2 in the vicinity of the boundary between the 15^{th} and 16^{th} bits (however, first half of the 16^{th} bit). Accordingly, the random wake-up signal WA turns to an active level earlier than the end timing. After that, at the end timing, the state of the switch 43 is switched to reset the charging voltage Vc2 to 0V, an initial voltage. Thus, the random wake-up signal WA again turns to a non-active level.

On the other hand, when data other than activation ID is set in the activation pattern area of the frame sent out to the communication channel LN, the third edge of focus necessarily occurs, as shown in FIG. 22, at a timing earlier than at the boundary between the 16^{th} and 17^{th} bits from the head. It should be noted that, in FIG. 22, the case of ID=0x551 is shown.

Specifically, the termination signal DTe turns to an active level at a timing earlier than the timing when the charging voltage Vc2 exceeds the reference voltage Vref2. Accordingly, the random wake-up signal WA is retained at a non-active level without turning to an active level.

In the present embodiment, the only differences from the second embodiment are the ID set in an activation pattern area and the process of detecting the ID. The remaining part of the present embodiment is operated completely in the same way as in the second embodiment. Accordingly, advantages similar to those of the second embodiment can be obtained.

The end timing detection circuit 50a of the present embodiment corresponds to the end timing detecting means recited in claim 9.

### Modifications

Some embodiments of the disclosure have been described so far. However, the disclosure is not limited to the above embodiments but may be modified and implemented in various manners without departing from the spirit of the disclosure.

In the specific pattern determination circuit 23 of the above embodiment, the duty ratio decoder 63 regards a bit pattern of each unit block as a duty signal, the bit pattern being set to a specific pattern area. Then, the length of period is compared between two signal levels in a unit block to thereby decode the bit pattern without using clocks.

However, for example, as shown in a specific pattern determination circuit 23a of FIG. 23, a PLL circuit 91 that reproduces clock signals from the reception signals Rsl may be operated when an activation frame is recognized (when the random wake-up signal WA turns active). Then, a decoder 92 may decode the bit pattern in the data field according to the clocks generated by the PLL circuit 91.

In this case, a data comparison circuit 93 may generate the allowance signal EN and the latch clock LCK based on the clock generated by the PLL circuit 91, instead of the edge detection signal ED. Also, in this case, the bit pattern set in the specific pattern area of the activation frame may be set on a unit block basis, a unit block consisting of a plurality of bits. Specifically, the bit pattern may be one which can be decoded with clocks having lower accuracy than the clocks used in the CAN controller 14. The PLL circuit 91 here corresponds to the clock generation circuit of the disclosure (claim 13). The decoder 92 corresponds to the decoder circuit of the disclosure (claim 13).

In the above embodiment, a stand-by state is determined when a dominant level continues for six or more consecutive bits. However, this may not impose a limitation. For example, the consecutive bits may be N+1 bits or more but may be 11 bits or less, where N is a maximum number of consecutive bits of the same level allowable in a frame with an insertion of stuff bits. It should be appreciated that the 11 bits correspond to the sum of the ACK delimiter (1 bit), the EOF (7 bits) and the intermission (3 bits) inserted between frames.

### Fourth Embodiment

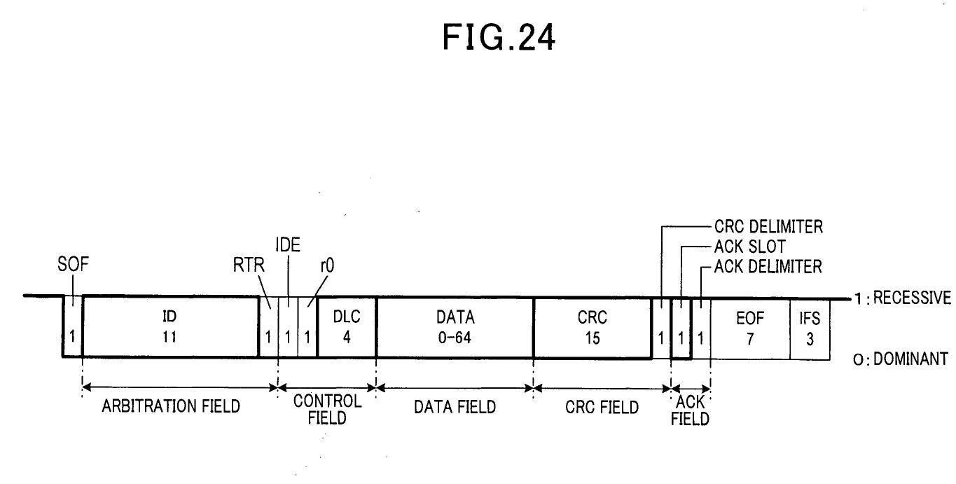

Referring to FIGS. 24-29A and 29B, a fourth embodiment of the present invention will now be described.

FIG. 24 shows the data frame, in which the intermission (IFS) is depicted which follows the EOF of the preceding frame data and consists of 3-bit recessive levels. In the preceding embodiments, the intermission (IFS) is omitted from being depicted from the drawings. The remaining configurations of the data frame are the same as those described already.

In the communication system 1, a data frame in which DLC is set to “0” (hereinafter also referred to as a “shortest set frame”), i.e. a frame omitted with a data field, is used as an activation frame for activating (waking up) the ECU 10 whose operational mode is a sleep mode. In other words, use of the shortest set frame is inhibited in the communication between the ECUs 10 whose operational mode is a normal mode.

The length of the activation frame (i.e., the shortest set frame) depends on the number of inserted stuff bits and, further, depends on the values set to ID and CRC sequences. Specifically, when no stuff bit is inserted, the length of the activation frame is minimized to the length amounting to 44 bits. Also, taking into account that no stuff bit is inserted into the 9 bits covering from ACK to EOF, the maximum length of the activation frame amounts to 51 (=(44−9)×6/5+9) bits.

A bit pattern used for ID of an activation frame should satisfy the following six bit patterns: <0>10101010101, <0>10101010100, <0>101010100XX, <0><0>1010100XXXX, <0>10100XXXXXX and <0>100XXXXXXXX, where <0> indicates SOF, and X indicates either “0” (dominant) or “1” (recessive).

Specifically, when a boundary condition is that two or more dominant bits are consecutively provided in a frame, and when an area from the head of the frame to a point where the boundary condition is met (this point is also referred to as a “boundary point”) is a specific pattern area, the specific pattern area is configured by even-number bits and has a bit pattern in which a dominant level and a recessive level are alternated. The initially indicated bit pattern (ID=0x555) does not include a bit pattern that meets the boundary condition. However, in this case, RTR and IDE following ID serve as a bit pattern that meets the boundary condition, while SOF and ID in the entirety serve as a specific pattern area.

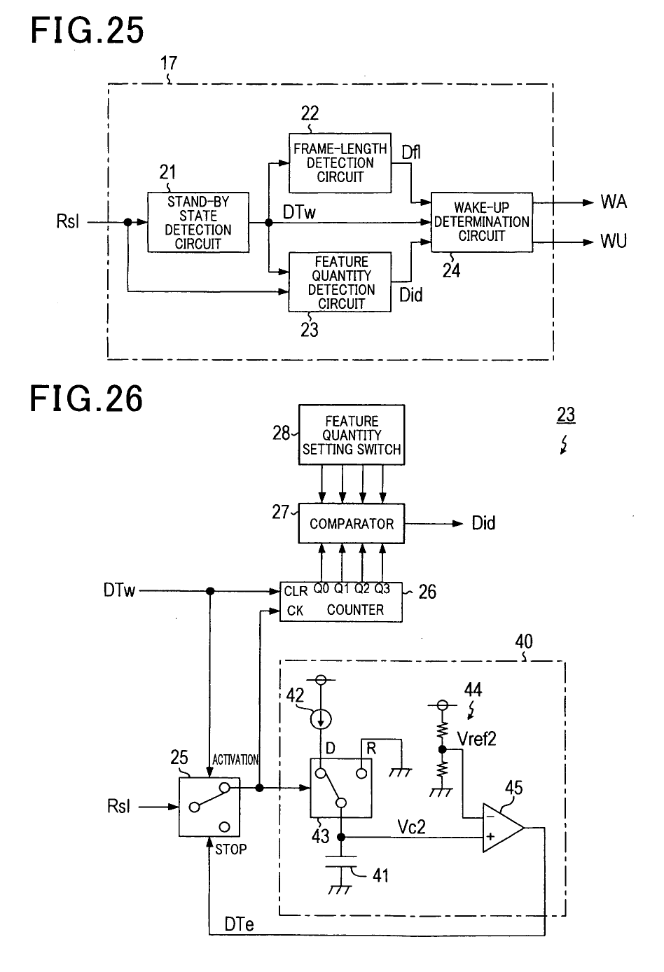

As shown in FIG. 25, the activation frame detector 17 includes a stand-by state detection circuit 21 and a frame-length detection circuit 22.

The stand-by state detection circuit 21 generates, as shown in FIG. 4, a stand-by state detection signal DTw that turns to a high level when the communication channel LN is in a stand-by state, based on the reception signal Rsl from the second comparator CP2. The frame-length detection circuit 22 generates an activation frame detection signal Df1 that turns to a low level in the case where the length of a period from when the stand-by state detection signal DTw turns from a high level to a low level until when again turning to a high level becomes not less than a preset activation period length.

The activation period length is set to 50 bits based on a maximum length of an activation frame (51 bits) and conditions under which the stand-by state detection signal DTw detects a stand-by state.

Specifically, at the end of a frame, the stand-by state detection signal DTw turns to an active level at a time point when a recessive level continues for six bits (time point when the 5^{th} bit of EOF is received), prior to the termination of EOF (prior to reception of the 7^{th} bit of EOF), to thereby make a determination whether or not the frame should be terminated. Using this, a determination regarding whether or not the frame in question is an activation frame can be made at a time point of the 49^{th} bit which is earlier, by two bits, than the maximum length of an activation frame in which DLC=0 (shortest set frame).

Thus, with the activation period length being set to 50 bits, the frame in question is determined to be an activation frame if the results of measurement of the frame length have not reached the activation period length at a time point when the stand-by state detection signal DTw has risen.

The activation frame detector 17 also includes a feature quantity detection circuit 23 and a wake-up determination circuit 24.

The feature quantity detection circuit 23 generates a coincidence detection signal Did that turns to a high level in the case where a predetermined quantity of feature extracted from a bit pattern coincides with a preset quantity of activation, during a period from when the stand-by state signal DTw turns from a high level to a low level (i.e., starts receiving a frame) until when a bit pattern of the frame satisfies a predetermined boundary condition (i.e., during the period corresponding to the specific pattern area). The wake-up determination circuit 24 latches the activation frame detection signal Dfl and the coincidence detection signal Did at a rising edge of the stand-by state detection signal DTw to thereby generate the random wake-up signal WA and the specific wake-up signal WU.

The feature quantity detection circuit 23 uses, as a quantity of feature, a value that is a count of edges at which a signal level turns from dominant to recessive (such an edge is hereinafter referred as an “edge of focus”). In other words, as is apparent from the bit pattern (mentioned above) that can be set in the specific pattern area of an activation frame, a value of any one of 1 to 6 is set as a quantity of activation.

FIG. 26 is a circuit diagram specifically illustrating a configuration of the feature quantity detection circuit 23.

As shown in FIG. 26, the feature quantity detection circuit 23 is provided in a path for supplying the reception signal Rsl and includes a switch 25 and a boundary point detection circuit 40.

The switch 25 is switched on (connects the path for supplying the reception signal Rsl) at a timing of a falling edge of the stand-by state detection signal DTw, i.e. at a timing of starting reception of a frame. The switch 25 is switched off (disconnects the path for supplying the reception signal Rsl) at a timing of a rising edge of a termination signal DTe described later (hereinafter referred to as “end timing”). The boundary point detection circuit 40 generates the termination signal DTe that turns to an active level (high level) upon detection of a point (boundary point) that satisfies a boundary condition, from the reception signal Rsl supplied from the switch 25. The boundary condition is a condition where a dominant level continues for a period of two or more bits of a transmission code in the communication channel LN.

Further, the feature quantity detection circuit 23 includes a counter 26, an activation amount setting switch 28 and a comparator 27.

The counter 26 is reset while the stand-by state detection signal DTw is at an active level. While the stand-by state detection signal DTw is at a non-active level (low level), the counter 26 counts the number of edges of the reception signals Rsl supplied via the switch 25, using the reception signals Rsl as clocks. The activation quantity setting switch 28 is configured by a plurality of switches. The activation quantity setting switch 28 is set with a bit pattern in a binary form expressing a quantity of activation (number of edges of focus in a specific pattern area) assigned to the ECU 10 in question. The comparator 27 generates the coincidence signal Did that turns to a high level when counts Q0 to Q3 of the counter 26 coincide with a set value of the activation amount setting switch 28.

The boundary point detection circuit 40 includes a capacitor 41, a constant current source 42, a switch 43, a voltage divider circuit 44 and a comparator 45.

The capacitor 41, with its one end being grounded, is able to charge/discharge electric charge. The switch 43 connects a non-grounded end of the capacitor 41 to a ground level or the constant current source 42 in accordance with a signal level of the reception signal Rsl. The voltage divider circuit 44 consists of a pair of resistors that divide voltage of the power supply VCC and generates a reference voltage (termination determining threshold) Vref2. The comparator 45 has an inverting input terminal to which the reference voltage Vref2 is applied and a non-inverting input terminal to which a voltage Vc2 of the non-grounded terminal of the capacitor 41 (hereinafter referred to “charging voltage”) is applied. Thus, the boundary point detection circuit 40 is configured to output the output of the comparator 45, in the form of the termination signal DTe.

The switch 43 is ensured to establish connection with the ground level when the reception signal Rsl is recessive, and with the constant current source 42 when dominant.

The current supplied by the constant current source 42, the capacity of the capacitor 41 and the level of the reference voltage Vref2 are set such that the charging voltage Vc3 will not reach the reference voltage Vref2 when the length of a period of continuously charging the capacitor 41 is less than a period corresponding to two bits of a transmission code, and that the charging voltage Vc2 becomes large exceeding the reference voltage Vref2 when the length of the period exceeds the period (in the present embodiment, the length defined by a point positioned approximately the center of the second bit of the two bits).

Logical circuits 102 and 104 are designed, as appropriate, so that a high-level signal is outputted according to the quantity of feature assigned to the ECU 10 in question when the quantity of feature coincides with the count of the counter 26.

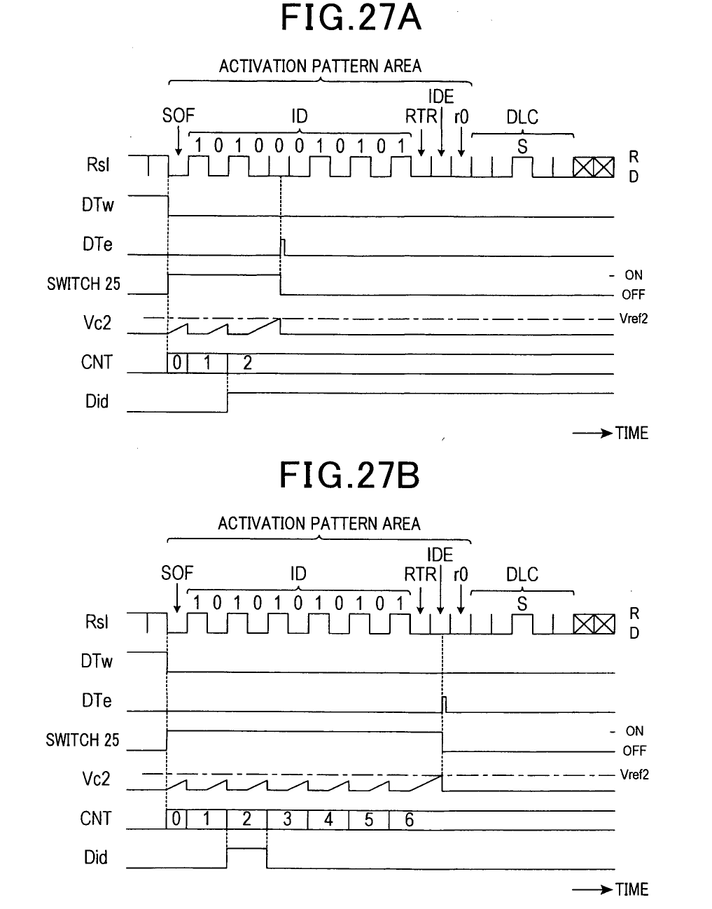

FIGS. 27A and 27B are timing diagrams illustrating an operation of each of components of the feature quantity detection circuit 23.

The quantity of activation assigned to the ECU 10 is rendered to be “2”. FIG. 27A shows the case of receiving a frame (ID=0x515) whose quantity of feature coincides with the quantity of activation. FIG. 27B shows the case of receiving a frame (ID=0x555) whose quantity of feature does not coincide with the quantity of activation. In FIGS. 27A and 27B, “S” indicates stuff bits that are inserted according to frame generation rules.

As shown in FIGS. 27A and 27B, when the stand-by state detection signal DTw turns to an non-active level at the head of the frame and the switch 25 is switched on, supply of the reception signals Rsl to the counter 26 and the boundary point detection circuit 40 is started.

In the boundary point detection circuit 40, the termination signal DTe turns to an active level when an area is detected, in which a dominant level continues for two consecutive bits (6^{th} bit from the head). Thus, when the switch 25 is turned off, supply of the reception signals Rsl to the counter 26 and the boundary point detection circuit 40 is stopped.

While the switch 25 is in an on-state, the counter 26 is operated. When the switch 25 is turned off, the supply of the reception signals Rsl is stopped to thereby stop the operation of the counter 26. The count CNT of the counter 26 of this moment is retained.

Then, when the count CNT (i.e. quantity of feature) of the counter 26 coincides with a set value (“2” here) of the activation quantity setting switch 28, the coincidence detection signal Did turns to a high level. Thus, the signal level at the time point when the switch 25 has been switched off is retained during a period when the stand-by state detection signal DTw stays at a low level, i.e. until the transmission of the frame is completed.

Specifically, when an activation frame is received, in which the quantity of feature coincides with the quantity of activation, the operation of the counter 26 is stopped, as shown in FIG. 27A, at a time point when the count CNT of the counter 26 coincides with the quantity of activation. Accordingly, the coincidence detection signal Did is retained at a high level.

On the other hand, when an activation frame is received, in which the quantity of feature does not coincide with the quantity of activation, the count CNT of the counter 26 once coincides with the quantity of activation, as shown in FIG. 27B, but the operation of the counter 26 is continued. Accordingly, the count CNT will differ from the quantity of activation at a time point when the operation of the counter 26 is stopped. In other words, the detection signal Did once turns to a high level but will eventually be retained at a low level.

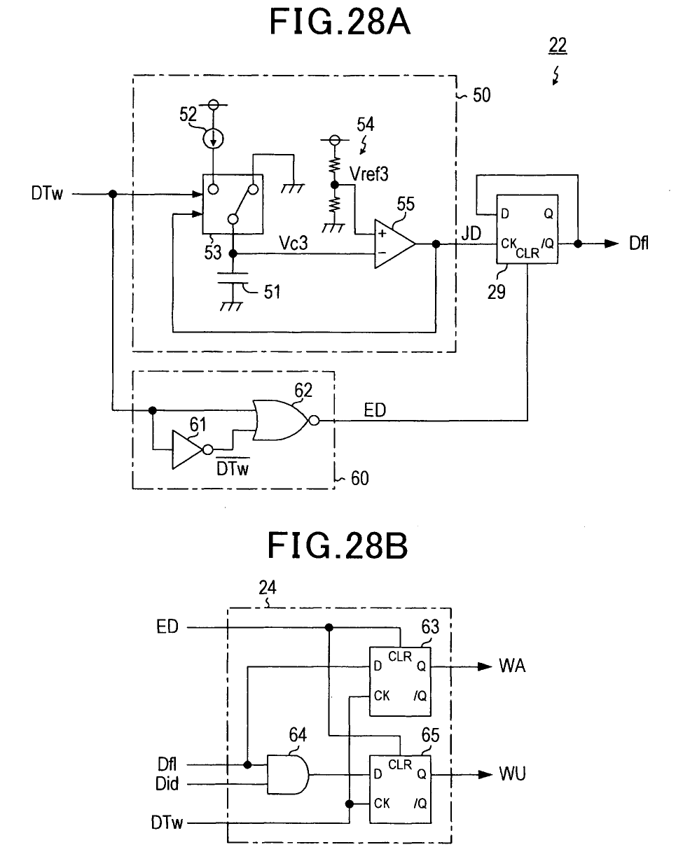

FIG. 28A is a circuit diagram specifically illustrating a configuration of the frame-length detection circuit 22.

The frame-length detection circuit 22 includes a period-length determination circuit 50, an edge detection circuit 60 and a latch circuit 29.

The period-length determination circuit 50 generates a determination signal JD that turns to a low level when the elapsed time from when the stand-by state detection signal DTw has turned from a high level to a low level exceeds a time corresponding to the activation period length (i.e. 49 bits). The edge detection circuit 60 generates an edge detection signal ED that indicates a timing of a falling edge of the stand-by state detection signal DTw. The latch circuit 29 is made up of a D-type flip-flop circuit having a reset terminal to which the edge detection signal ED is inputted and a clock terminal to which the determination signal JD is inputted, the flip-flop circuit being connected with an inverted output and a data input. The latch circuit 29 generates an activation frame detection signal Dfl that turns to a high level at a time point of being reset, and turns to a low level at a time point when the determination signal JD turns from a low level to a high level.

Of these components, the edge detection circuit 60 is a known circuit including an inverting circuit (NOT gate) 61 and a negative OR circuit (NOR gate) 62

The inverting circuit 61 inverts the signal level of the stand-by state detection signal DTw. The NOR gate 62 inputs the output of the stand-by state detection signal DTw and the NOT gate 61, i.e. inputs the inverting signal of the stand-by state detection signal DTw. When both of the stand-by state detection signal DTw and the NOT gate 61 are at a low level, the output of the NOR gate 62 turns to a high level. The output of the NOR gate 62 is outputted as the edge detection signal ED. In other words, the edge detection circuit 60 outputs a pulse signal, as the edge detection signal ED, at every timing of a falling edge of the stand-by state detection signal DTw, the pulse signal having a width corresponding to a delay time of the NOT gate 61.

The period-length determination circuit 50 includes a capacitor 51, a constant current source 52, a switch 53, a voltage divider 54 and a comparator 55.

The capacitor 51, with its one end being grounded, is able to charge/discharge electric charge. The switch 53 connects a non-grounded end of the capacitor 51 to a ground level or to the constant current source 52 in accordance with the stand-by state detection signal DTw and the determination signal JD. The voltage divider circuit 54 consists of a pair of resistors that divide the power supply voltage VCC to generate the reference voltage (period determining threshold) Vref3. The comparator 55 has an inverting input terminal to which the reference voltage Vref3 is applied and a non-inverting input terminal to which the voltage Vc3 of the non-grounded end of the capacitor 51 (hereinafter referred to as “charging voltage”) is applied. Thus, the period-length determination circuit 50 is configured to output the output of the comparator 55, in the form of the determination signal JD.

The switch 53 is ensured to be switched to the constant current source 52 at a timing of a falling edge of the stand-by state detection signal DTw. The switch 53 is also ensured to be switched to the ground level at a timing of a falling edge of the stand-by state detection signal DTw or at a timing of a rising edge of the determination signal JD, whichever is earlier.

The current supplied by the constant current source 52, the capacity of the capacitor 51 and the reference voltage. Vref3 are set such that the charging voltage Vc3 will not reach the reference voltage Vref3 when the length of a period of continuously charging the capacitor 51 is not more than a period corresponding to 48 bits of a transmission code, and that the charging voltage Vc3 exceeds the reference voltage Vref when the length of the period exceeds the period, i.e. when the length is reaching the 49^{th} bit.

Specifically, the period corresponding to the reference voltage Vref3 is an activation period length. The activation period length is set so as to correspond to the length of an area from the head of a frame to a point over a boundary between the 48^{th} and the 49^{th} bits.

FIG. 28B is a circuit diagram specifically illustrating a configuration of the wake-up determination circuit 24.

The wake-up determination circuit 24 includes a latch circuit 63, an AND circuit (AND gate) 64 and a latch circuit 65.

The latch circuit 63 is made up of a D-type flip-flop circuit and reset by the edge detection circuit ED. The latch circuit 63 is connected so as to latch the signal level of the activation frame detection signal Dfl at a timing of a rising edge of the stand-by state detection signal DTw. The AND gate 64 inputs the activation frame detection signal Dfl and the coincidence detection signal Did. The output of the AND circuit 64 turns to a high level when both of the activation frame detection signal Dfl and the coincidence detection signal Did are at a high level. The latch circuit 65 is made up of a D-type flip-flop circuit and reset by the edge detection circuit ED. The latch circuit 65 is connected so as to latch the signal level of the output of the AND gate 64 at a timing of a rising edge of the stand-by state detection signal DTw.

It should be appreciated that the output of the latch circuit 63 corresponds to the random wake-up signal WA and the output of the latch circuit 65 corresponds to the specific wake-up signal WU.

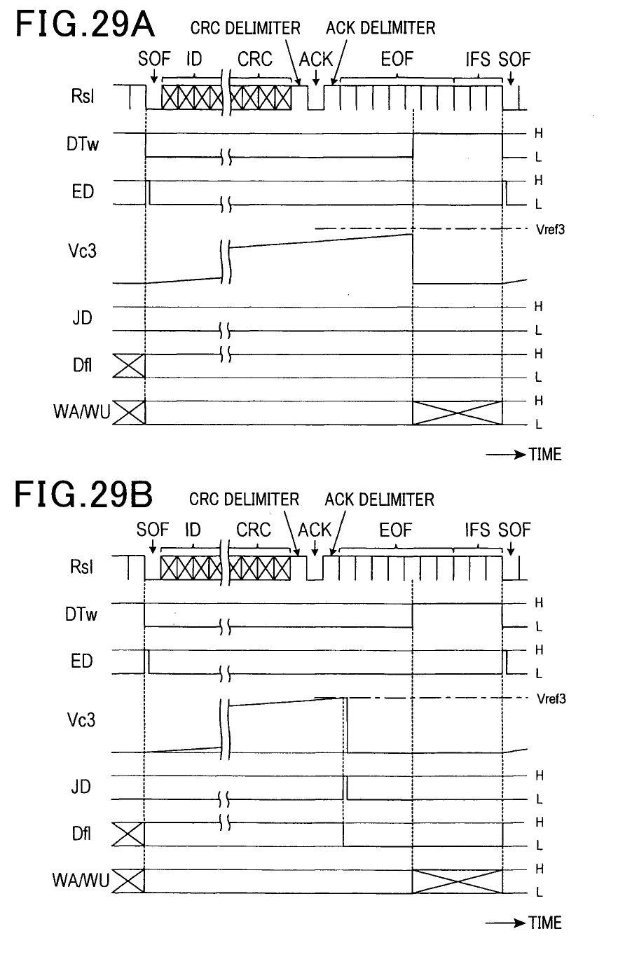

FIGS. 29A and 29B are timing diagrams illustrating an operation of each of the frame-length detection circuit 22 and the wake-up determination circuit 24. FIG. 29A shows the case of receiving an activation frame. FIG. 29B shows the case of receiving a normal data frame, not an activation frame.

As shown in FIGS. 29A and 29B, the signal level of the wake-up signals WA/WU and the activation frame detection signal Dfl is initialized at a time point of a falling edge of the stand-by state detection signal DTw, i.e. at a time point of starting reception of a frame. At the same time, charge of the capacitor 51 configuring the period-length determination circuit 50 is started.

Then, as shown in FIG. 29A, when an activation frame is received, the charging voltage Vc3 of the capacitor 51 will not reach the reference voltage Vref3 but will be reset at a timing of a rising edge of the stand-by state detection signal DTw. Thus, the determination signal JD is retained at a low level. As a result, the activation frame detection signal Dfl is also retained at an initial state of high level.

Specifically, at a timing of a rising edge of the stand-by state detection signal DTw, the activation frame detection signal Dfl is at a high level. Accordingly, at this timing, the random wake-up signal WA turns to an active level, while the specific wake-up signal WU turns to a signal level of the coincidence detection signal Did. After that, the signal level of the wake-up signals WA/WU is retained until the stand-by state detection signal DTw turns to a low level, i.e. until the subsequent frame is detected.

Meanwhile, as shown in FIG. 29B, when a normal data frame is received, the charging voltage Vc3 of the capacitor 51 reaches the reference voltage Vref3 (reaches the 50^{th} bit from the head of the frame) at a timing earlier than a rising edge of the stand-by state detection signal DTw. Accordingly, the determination signal JD turns to a high level. Thus, the activation frame detection signal Dfl turns from a high level to a low level.

Specifically, the activation frame detection signal Dfl is at a low level at a timing of a rising edge of the stand-by state detection signal DTw. Accordingly, the random wake-up signal WA is retained at a non-active level. Meanwhile, the specific wake-up signal WU is also retained at a non-active level, irrespective of the signal level of the coincidence detection signal Did.

Specifically, when an activation frame is received, in which DLC=0 is set and the frame length corresponds to 49 bits or less, the random wake-up signal WA turns to an active level. The specific wake-up signal WU will also turn to an active level, when the number of edges (quantity of feature) extracted from a bit pattern in the specific pattern area coincides with the amount of activation assigned in advance to the ECU 10.

As described above, in the communication system 1, the ECU 10 in a sleep mode determines whether or not the communication channel LN is in a stand-by state (state where a recessive level continues for six or more consecutive bits). When the state turns from a stand-by state to a non-stand-by state, it is determined whether or not the length of a period up to a time point when the state again turns to a stand-by state is less than the activation period length. At the same time, it is determined whether or not the quantity of feature (number of edges of focus) extracted from the bit pattern set in the specific pattern area of the frame corresponds to the quantity of activation assigned in advance to the ECU 10 in question. When the length of the period is less than the activation period length, the random wake-up signal WA is permitted to turn to an active level. When the quantity of feature coincides with the quantity of activation, the specific wake-up signal WU is also permitted to turn to an active level.

Accordingly, according to the communication system 1, the CAN controller 14 and the clock circuit are not required to be operated for making a determination whether or not an activation frame has been received. Thus, power consumption of the ECU 10 in a sleep mode is reduced to a great extent.

Further, according to the communication system 1, not all the nodes that have received respective activation frames are unconditionally activated, but only those nodes specified in the activation frames are activated. Thus, those nodes which are not required to be activated will not be unnecessarily activated. As a result, power consumption of the communication system 1 in its entirety will be reduced.

In the present embodiment, the stand-by state detection circuit 21 corresponds to the stand-by state detecting means. The frame-length detection circuit 22 corresponds to the frame-length determining means. The boundary point detection circuit 40 corresponds to the boundary point detecting means. The counter 26, the comparator 27 and the activation quantity setting switch 28 correspond to the feature quantity 5, determining means. The wake-up determination circuit 24 corresponds to the wake-up determining means.

Further, in the boundary point detection circuit 40, the capacitor corresponds to the first capacitive element and the constant current source 42 and the switch 43 correspond to the first charge circuit. In the period-length detection circuit 50 of the frame-length detection circuit 22, the capacitor 51 corresponds to the second capacitive element and the constant current source 52 and the switch 53 correspond to the second charge circuit. In the stand-by state detection circuit 21, the capacitor 31 corresponds to the third capacitive element and the constant current source 32 and the switch 33 correspond to the third charge circuit.

Further, the CAN controller 14 corresponds to the communication control means. The wake-up process and the sleep process performed by the microcomputer 11, as well as the configuration for starting/stopping the clock circuit, which is a part of the microcomputer 11, correspond to the operational mode transitioning means.

### Fifth Embodiment

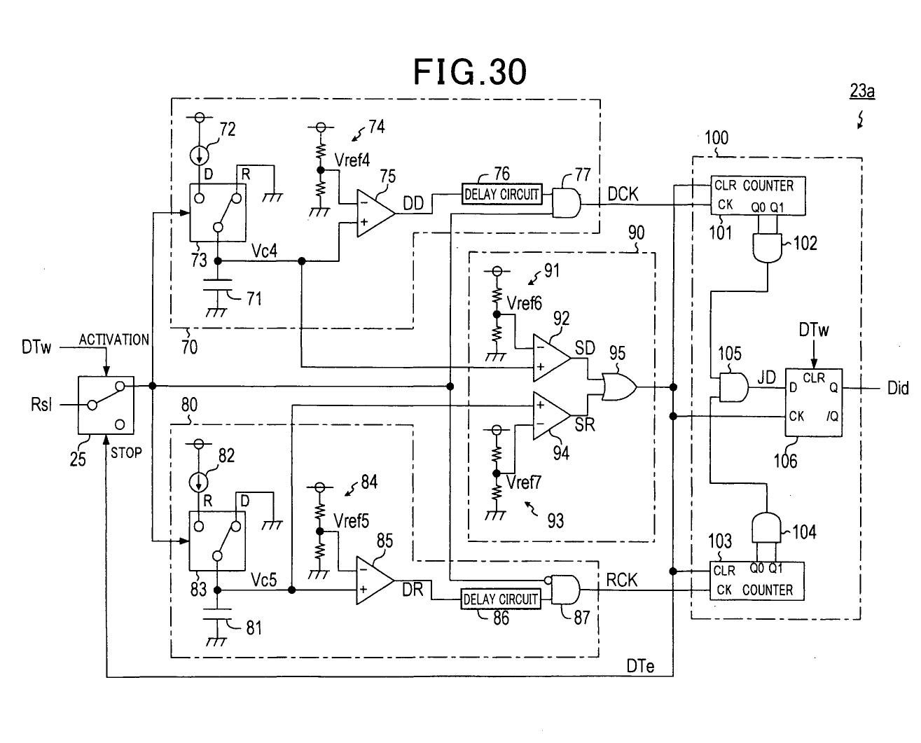

With reference to FIGS. 30-32, hereinafter is described a fifth embodiment of the disclosure.

The fifth embodiment is different from the fourth embodiment in the ID used for specifying a node to be activated, a boundary condition and the configuration of a feature quantity detection circuit 23a. The description set forth below will be given focusing on the difference.

A data frame set with DLC=0 similar to the one in the fourth embodiment is used as an activation frame.

Any of the following five bit patterns is used as an ID of the activation frame: <0>01100110011, <0>0110011000X, <0>01100111XXX, <0>011000XXXXX and <0>0111XXXXXXX, where <0> indicates SOF, X indicates either “0” (dominant) or “1” recessive.

Specifically, in the frame, let us assume that three or more consecutive bits of the same signal level constitute a boundary condition, an area from the head of the frame to a point satisfying the boundary condition (also referred to as a “boundary point”) is a specific pattern area, an area in which signal level is dominant and has a width of two bits is a first area, and an area in which signal level is recessive and has a width of two bits is a second area. In this case, in a bit pattern set in the specific pattern area, the first area and the second area are alternated.

The firstly indicated bit pattern (ID=0x333) does not include a bit pattern satisfying the boundary condition. In this case, RTR, IDE and r0 following ID serve as the bit pattern satisfying the boundary condition. Thus, SOF and the entire ID serve as the specific pattern area.

When an ID includes a bit pattern of three consecutive bits of the same signal level, this part is the boundary point and thus SOF and a part of the ID preceding the boundary point serve as an activation pattern area.

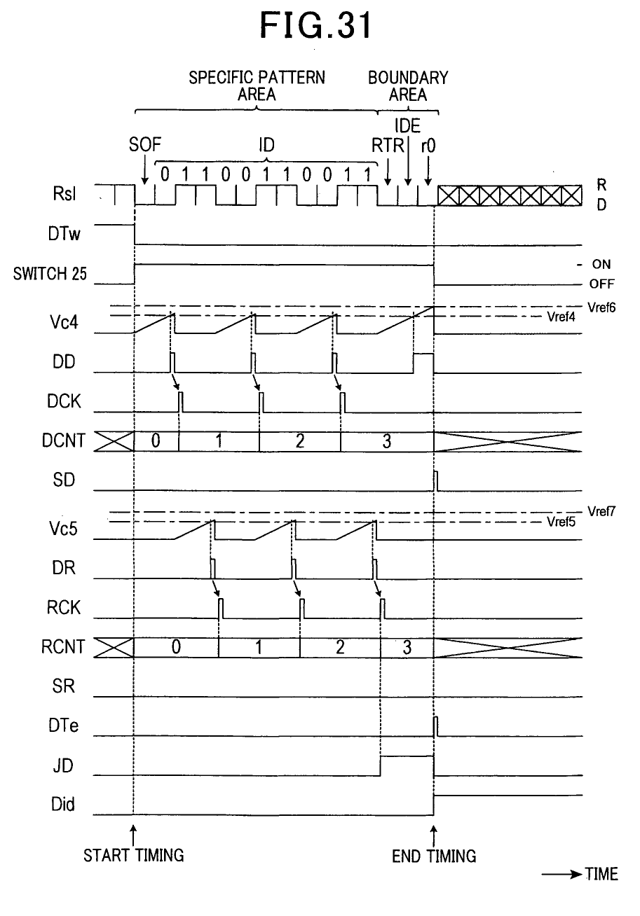

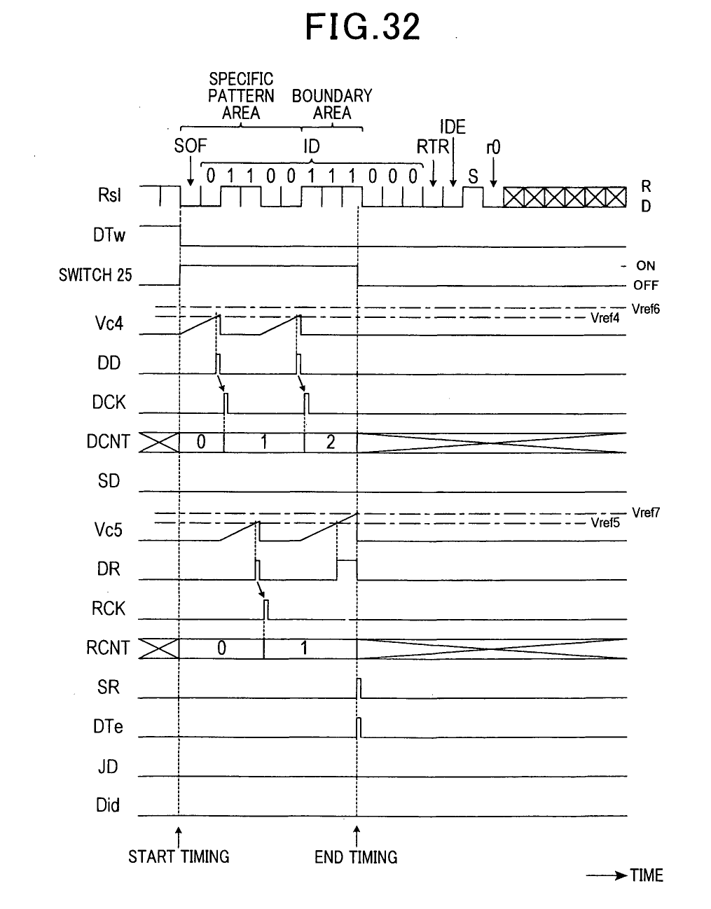

FIG. 30 is a circuit diagram specifically illustrating a configuration of the feature quantity detection circuit 23a. FIGS. 31 and 32 are timing diagrams illustrating an operation of each of components in the feature quantity detection circuit 23a.

As shown in FIG. 30, the feature quantity detection circuit 23a includes a switch 25, a first area detection circuit 70 and a second area detection circuit 80.

The switch 25 is provided in a path for supplying the reception signal Rsl. The switch 25 turns to an on-state (state of connecting the supply path) at a timing of a falling edge of the stand-by state detection signal DTw (hereinafter referred to as “start timing”), i.e. at a timing of starting reception of a frame. The switch 25 turns to an off-state (state of disconnecting the supply path) at a timing of a rising edge of a termination signal DTe described later (hereinafter referred to as “end timing”). The first area detection circuit 70 generates a first area detection clock DCK that turns to a high level for a short time every time a first area where a dominant level continues for a period corresponding to two bits of a transmission code in the communication channel LN, is detected from a reception signal supplied via the switch 25. The second area detection circuit 80 generates second area detection clock RCK that turns to a high level for a short time every time a second area where a recessive level continues for a period corresponding to two bits of a transmission code in the communication channel LN, is detected from a reception signal supplied via the switch 25.

The feature quantity detection circuit 23a also includes an end timing detection circuit 90 and a feature quantity determination circuit 100.

The end timing detection circuit 90 generates the termination signal DTe that turns to an active level (high level) when an area is detected, in which the same signal level continues for more than a period corresponding to three bits (boundary point) of a transmission code in the communication channel LN, from the reception signal Rsl supplied via the switch 25. The feature quantity determination circuit 100 calculates a quantity of feature (number of generations of pulses) based on each of the first area detection clock DCK and the second area detection clock RCK and generates the coincidence detection signal Did that turns to an active level (high level) when the quantity of feature coincides with a preset quantity of activation (both of the quantities are “3” in the present embodiment).

The first area detection circuit 70 includes a capacitor 71, a constant current source 72, a switch 73, a voltage divider circuit 74, a comparator 75, a delay circuit 76 and a logical circuit 77.

The capacitor 71, with its one end grounded, is able to charge/discharge electric charge. The switch 73 connects a non-grounded end of the capacitor 71 to a ground level or to the constant current source 72 in accordance with the reception signal Rsl. The voltage divider circuit 74 consists of a pair of resistors that divide the power supply voltage VCC and generates a reference voltage Vref4. The comparator 75 has an inverting input terminal to which the reference voltage Vref4 is applied and a non-inverting input terminal to which a voltage Vc4 (charging voltage) of the non-grounded end of the capacitor 71 is applied. The delay circuit 76 delays the output of the comparator 75 (first area candidate detection signal DD) by a period substantially corresponding to one bit of a transmission code. The logical circuit 77 inputs the first area candidate detection signal DD delayed by the delay circuit 76 and the reception signal Rsl. The logical circuit 77 outputs a high-level signal when both of the signals are at a high level. Thus, the first area detection circuit 70 is configured to supply the output of the logical circuit 77 to the feature quantity determination circuit 100, in the form of the first area detection clock DCK.

It should be appreciated that the switch 73 is ensured to be connected to the ground level when the reception signal Rsl is recessive and to the constant current source 72 when dominant. Further, the switch 73 is ensured to be connected to the ground level when the switch 25 is in an off-state.

The current supplied by the constant current source 72 and the capacity of the capacitor 71, the reference voltage Fref4 are set such that the charging voltage Vc4 will not reach the reference voltage Vref4 when the length of a period for continuously charging the capacitor 71 is not more than a period corresponding to one bit of a transmission signal, and that the charging voltage Vc4 will exceed the reference voltage Vref4 when the length of the period exceeds the period (i.e. when the length is reaching the second bit).

As shown in FIGS. 31 and 32, there is an area where signal level of the reception signal Rsl turns to a dominant level for two or more consecutive bits (hereinafter referred to as a “candidate area”). In this case, the first area candidate detection signal DD, which is generated by the first area detection circuit 70 configured as described above, turns to a high level midway of the second bit of the candidate area, and again turns to a low level at a timing when the signal level of the reception signal Rsl turns to a recessive level.

In the case where a candidate area is configured by two bits, the reception signal Rsl turns to a recessive (high) level at a timing (3^{rd} bit from the head of the candidate area) when the first area candidate detection signal DD delayed by the delay circuit 76 is inputted to the logical circuit 77. Accordingly, the delayed first area candidate detection signal DD is outputted as it is in the form of the first area detection clock DCK that is the output of the logical circuit 77.

Meanwhile, in the case where a candidate area is configured by three or more dominant bits, the reception signal Rsl turns to a dominant (low) level at a timing when the first area candidate detection signal DD delayed by the delay circuit 76 is inputted to the logical circuit 77. Accordingly, the output of the logical circuit 77, i.e. the first area detection clock DCK, is retained at a low level.

In other words, the first area detection clock DCK is configured only by pulse signals generated when a first area is detected, in which a dominant level continues for a period corresponding to two bits.

The second area detection circuit 80 includes a capacitor 81, a constant current source 82, a switch 83, a voltage divider circuit 84, a comparator 85, a delay circuit 86 and a logical circuit 87.

The capacitor 81, with its one end being grounded, is able to charge/discharge electric charge. The switch 83 connects a non-grounded end of the capacitor 81 to a ground level or to the constant current source 82 according to the reception signal Rsl. The voltage divider circuit 84 consists of a pair of resistors that divide the power supply voltage VCC and generates a reference voltage Vref5. The comparator 85 has an inverting input terminal to which the reference voltage Vref 5 is applied and a non-inverting input terminal to which a charging voltage Vc5 of the capacitor 81 is applied. The delay circuit 86 delays the output of the comparator 85 (second area candidate detection signal DR) by a period substantially corresponding to one bit of a transmission code. The logical circuit 87 outputs high-level signal when the second area candidate detection signal DR delayed by the delay circuit 86 is at a high level and the reception signal Rsl is at a low (dominant) level. Thus, the second area detection circuit 80 is configured to supply the output of the logical circuit 87 to the feature quantity determination circuit 100, in the form of the second area detection clock RCK.

It should be appreciated that the switch 83 is ensured to be connected to the ground level when the reception signal Rsl is recessive and to the constant current source 82 when dominant. Further, the switch 83 is ensured to be connected to the ground level when the switch 25 is in an off-state.

The current of the constant current source 82, the capacity of the capacitor 81 and the reference voltage Vref5 are set such that the charging voltage Vc5 will not reach the reference voltage Vref5 when the length of a period for continuously charging the capacitor 81 is not less than a period corresponding to one bit of a transmission code, and that the charging voltage Vct will exceed the reference voltage Vref5 when the length of the period exceeds the period (i.e. when the length is reaching the second bit).

As shown in FIGS. 31 and 32, there is an area where signal level of the reception signal Rsl turns to a dominant level for two or more consecutive bits (hereinafter referred to as a “candidate area”). In this case, the second area candidate detection signal DR, which is generated by the second area detection circuit 80 configured as described above, turns to a high level midway of the second bit of the candidate area, and again turns to a low level at a timing when the signal level of the reception signal Rsl turns to a dominant level.

In the case where a candidate area is configured by two bits, the reception signal Rsl turns to a dominant (low) level at a timing when the second area candidate detection signal DR delayed by the delay circuit 86 is inputted to the logical circuit 87. Accordingly, the delayed second area candidate detection signal DR is outputted as it is in the form of the second area detection clock RCK that is the output of the logical circuit 87.

Meanwhile, in the case where a candidate area is configured by three or more bits, the reception signal Rsl turns to a recessive (high) level at a timing when the second area candidate detection signal DR delayed by the delay circuit 86 is inputted to the logical circuit 87. Accordingly, the output of the logical circuit 87, i.e. the second area detection clock RCK, is retained at a low level.

In other words, the second area detection clock RCK is configured only by pulse signals generated when a second area is detected, in which a recessive level continues for a period corresponding to two bits.

Referring again to FIG. 30, the end timing detection circuit 90 includes a voltage divider circuit 91, a comparator 92, a voltage divider circuit 93, a comparator 94 and a logical circuit 95.

The voltage divider circuit 91 consists of a pair of resistors that divide the power supply voltage VCC and generates a reference voltage Vref6. The comparator 92 has an inverting input terminal to which the reference voltage Vref6 is applied and a non-inverting input terminal to which a charging voltage Vcr4 of the capacitor 71. The voltage divider circuit 93 consists of a pair of resistors that divide the power supply voltage VCC and generates a reference voltage Vref7. The comparator 94 has an inverting input terminal to which the reference voltage Vref7 is applied and a non-inverting input terminal to which a charging voltage Vcr5 of the capacitor 81. The logical circuit 95 outputs a high-level signal when at least one of an output SD of the comparator 92 and n output SR of the comparator 94 is at a high level. Thus, the end timing detection circuit 90 is configured to supply the output of the logical circuit 95 to individual components, in the form of the termination signal DTe.

The reference voltage Vref6 is set based on the current supplied by the constant current source 72 and the capacity of the capacitor 71. Specifically, the reference voltage Vref6 is set such that the charging voltage Vc4 will not reach the reference voltage Vref6 when the length of a period for continuously charging the capacitor 71 is not more than a period corresponding to two bits of a transmission code, and that the charging voltage Vc4 exceeds the reference voltage Vref6 when the length of the period exceeds the period (when the length is reaching the 3^{rd} bit).

Similarly, the reference voltage Vref7 is set based on the current supplied by the constant current source 82 and the capacity of the capacitor 81. Specifically, the reference voltage Vref7 is set such that the charging voltage Vc5 will not reach the reference voltage Vref7 when the length of a period for continuously charging the capacitor 81 is not more than a period corresponding to two bits of a transmission code, and that the charging voltage Vc5 exceeds the reference voltage Vref7 when the length of the period exceeds the period (when the length is reaching the 3^{rd} bit).

Specifically, the end timing detection circuit 90 is configured to generate the termination signal DTe that turns to a high level at a time point when the same signal level continues for three consecutive bits in the frame to thereby stop the operation of the first are detection circuit 70 and the second area detection circuit 80. When the operation of the first and second area detection circuit 70 and 80 is stopped, the charging voltages Vc4 and Vc5, respectively, are reset. Accordingly, the signal level of the termination signal DTe, after being turned to a high level, is again soon turned to a low level.

The feature quantity determination circuit 100 includes a counter 101 and a logical circuit 102.

The counter 101 of a plurality of digits (two digits in the present embodiment) is reset when the termination signal DTe is at a high level, and operates according to the first area detection clock DCK supplied by the first area detection circuit 70. The logical circuit 102 outputs a high-level signal when outputs Q0 and Q1 of the counter 101 are both at a high level, i.e. when the count is “3”.

The feature quantity determination circuit 100 also includes a counter 103, a logical circuit 104, a logical circuit 105 and a latch circuit 106.

The counter 103 of a plurality of digits (two digits in the present embodiment) is reset when the termination signal DTe is at a high level and operates according to the second area detection clock RCK supplied by the second area detection circuit 80. The logical circuit 104 outputs a high-level signal when outputs Q0 and Q1 of the counter 103 are both at a high level, i.e. when the count is “3”. The logical circuit 105 outputs a high-level signal when the outputs of both of the logical circuits 102 and 104 are at a high level. The latch circuit 106, which is made up of a D-type flip-flop, is reset when the stand-by state detection signal DTw is at a high level and latches an output JD of the logical circuit 105 at a timing of a rising edge of the termination signal DTe. Thus, the feature quantity determination circuit 100 is configured to supply the output of the latch circuit 106 to the wake-up determination circuit 24, in the form of the coincidence detection signal Did.

Thus, the feature quantity determination circuit 100 allows the coincidence detection signal Did to turn to an active level (high level) when the first area and the second area are each detected three times in the specific pattern area.

The feature quantity detection circuit 23a configured in this way starts operation at a rising edge, i.e. at the start timing, of the stand-by state detection signal DTw.

When an activation frame in which an ID (=0x333) for activating the ECU 10 in question is sent out to the communication channel LN, an area in which the same signal level continues for three consecutive bits appears, as shown in FIG. 31, for the first time in RTR, IDE and r0. Accordingly, this part serves as the boundary point and thus SOF and the entire ID serve as a specific pattern area.

Then, the charging voltage Vc4 exceeds the reference voltage Vref6 at a timing of reaching r0 of the boundary point to thereby turn the termination signal DTe to a high level. This timing is the end timing.

The bit pattern in the specific pattern area includes three dominant areas (three first areas) each made up of two consecutive bits, which are alternated by three recessive areas (three second areas) each made up of two consecutive bits. Accordingly, in a period from the start timing to the end timing, the first area detection circuit 70 generates the first area detection clock DCK consisting of three pulse signals, the number being the same number as that of the first areas. Meanwhile, the second area detection circuit 80 also generates the second area detection clock RCK consisting of three pulse signals, the number being the same number as that of the second areas.

Specifically, a count DCNT of the counter 101 that operates according to the first area detection clock DCK indicates the number of the first areas detected in the specific pattern area. Also, a count RCNT of the counter 103 that operates according to the second area detection clock RCK indicates the number of the second areas detected in the specific pattern area.

The counts DCNT and RCNT (quantities of feature) coincide with the quantities of activation (both are “3”) assigned to the ECU 10 in question. Accordingly, the random wake-up signal WA turns to an active level at a time point when the third second area is detected and the count RCNT indicates “3” (the count DCNT indicates “3” at a timing earlier than this timing). This signal level is retained until the end timing.

On the other hand, when an activation frame in which an ID (=0x338) for activating ECUs other than the ECU 10 in question is sent out to the communication channel LN, an area in which the same signal level continues for three consecutive bits appears, as shown in FIG. 32, for the first time at the 6^{th} to 8^{th} bits of the ID. Accordingly, this part serves as the boundary point and thus SOF and a part of the 1^{st} to 5^{th} bits of the ID serve as the specific pattern area.

Specifically, the charging voltage Vc5 exceeds the reference voltage Vref7 at a timing of reaching the 8^{th} bit of the ID to thereby turn the termination signal DTe to a high level. This timing is the end timing.

The bit pattern in the specific pattern area consists of the first area, the second area and the first area. Accordingly, in a period from the start timing to the end timing, the first area detection circuit 70 generates the first area detection clock DCK consisting of two pulse signals. Meanwhile, the second area detection circuit 80 generates the second area detection clock RCK consisting of a single pulse signal.

Specifically, the count DCNT of the counter 101 indicates “2”, while the count RCNT of the counter 103 indicates “1”. Thus, neither of the counts DCNT and RCNT coincides with the quantities of activation (both are “3”). Accordingly, the coincidence detection signal Did does not turn to an active level but is retained at a non-active level.

The present embodiment described above is different from the fourth embodiment only in the boundary condition used for detecting the boundary point and in the configuration of the feature quantity detection circuit 23a. The remaining part of the present embodiment operates in completely the same way. Thus, the same advantages as those of the fourth embodiment can be obtained.

In the present embodiment, the boundary condition has been that the same signal level continues for three bits, and the width of the first and second areas has been two bits. However, when the boundary condition is that the same signal level continues for M bits, the first and second areas may have a width corresponding to less than M bits. Also, the width of the first and second areas may not have to be necessarily the same. Alternatively, one of dominant and recessive levels may be used as an attractive level to provide a boundary condition that the attractive level continues for M bits. In this case, of the first and second areas, the one having the same signal level as that of the attractive level may required to have a width of less than M bits, but the other one may have an optional width (however, a limitation is imposed by stuff bit insertion rules).

### Sixth Embodiment

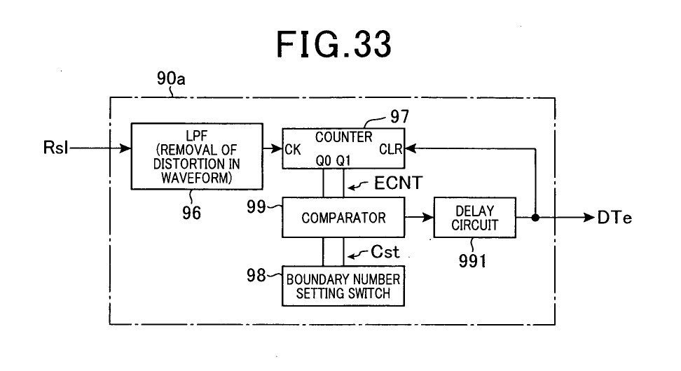

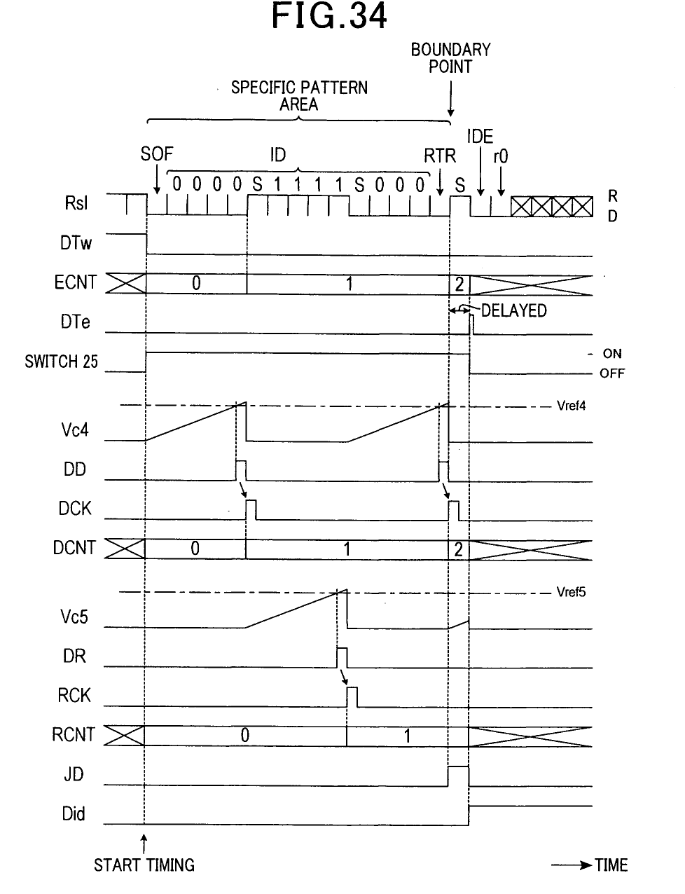

Referring now to FIGS. 33-35, hereinafter is described a sixth embodiment of the present invention.

The sixth embodiment is different from the fourth embodiment only in the ID used for specifying a node to be activated, the boundary condition and the configuration of the feature quantity determination circuit. Therefore, the description hereinafter is given focusing on the differences.

In the present embodiment, the number of rising edges is counted, at which the signal level of the reception signal Rsl turns from a dominant level to a recessive level. In the present embodiment, the boundary condition is that the count equals to a preset activation number Cst.

Similar to the fourth and third embodiments, a data frame in which DLC=0 is set is used as an activation frame.

However, in the activation frame used here, an area in which a dominant level continues for Md bits (Md is an integer of not less than “1” (Md≧1)) is a first area, and an area in which a recessive level continues for Mr bits (Mr is an integer of not less than “1” (Mr≧1)) is a second area. Also, an ID used in the activation frame includes a bit pattern in which the first areas and the second areas are alternately juxtaposed. Further, in the activation frame, the numbers of times that both of the areas appear in the pattern (quantities of feature) before the boundary condition is met are unique (quantities of activation Td and Tr).

Specifically, for example, such IDs may be used as: ID=0x555 (Cst=6, Md=Mr=1, Td=6, Tr=5) having a bit pattern {<0>10101010101}; ID=0x249 (Cst=4, Md=2, Mr=1, Td=4, Tr=3) having a bit pattern {<0>01001001001} and ID=07FF (Cst=3, Md=1, Mr=5, Td=3, Tr=2) having a bit pattern {<0>11111(0)11111(0)1}. Also, using an area of RTR following ID, such IDs may also b used as: ID=0x078 (Cst=2, Md=Mr=5, Td=2, Tr=1) having a bit pattern {<0>0000(1)1111(0)0000(1)}.

A feature quantity determination circuit has a configuration obtained by replacing the end timing detection circuit 90 in the feature quantity detection circuit 23a of the fifth embodiment, with an end timing detection circuit 90a shown in FIG. 33.

The end timing detection circuit 90a includes a low-pass filter 96, a counter 97, a boundary number setting switch 98, a comparator 99 and a delay circuit 991.

The low-pass filter 96 is provided to remove distortion of the reception signal Rsl supplied via the switch 25. The counter 97 inputs, as clocks, the reception signals Rsl supplied via the low-pass filter 96 and counts the number of rising edges in the reception signals Rsl. The boundary number setting switch 98 sets the number of boundaries Cst (hereinafter referred to as “boundary number Cst”) assigned to the ECU 10 in question. The comparator 99 generates a signal that turns to an active level (high level) when the count of the counter 97 coincides with a boundary number set in the boundary number setting counter 98. The delay circuit 991 delays the output of the comparator 99 by about one bit of a transmission code, to generate the termination signal DTe. The counter 97 is connected such that the count is cleared when the termination signal DTe is at an active level.

The individual ECUs 10 are assigned with any one of the IDs for activation set forth above. The first area detection circuit 70, the second area detection circuit 80 and the feature quantity determination circuit 100 are set based on Md, Mr, Td and Tr in the assigned ID.

Specifically, the current supplied by the constant current source 72, the capacity of the capacitor 71 and the reference voltage Vref4 of the first area detection circuit 70 are set such that the charging voltage Vc4 will not reach the reference voltage Vref4 when the length of a period for continuously charging the capacitor 71 based on the width Md of the first area is not more than a period corresponding to (Md−1) bits of a transmission code, and that the charging voltage Vc4 will exceed the reference voltage Vref4 when the length of the period exceeds the period (i.e. when the length of the period is reaching the Md^{th} bit).

Similarly, the current supplied by the constant current source 82, the capacity of the capacitor 81 and the reference voltage Vref5 of the first area detection circuit 80 are set such that the charging voltage Vc5 will not reach the reference voltage Vref5 when the length of a period for continuously charging the capacitor 81 based on the width Mr of the second area is not more than a period corresponding to (Mr−1) bits of a transmission code, and that the charging voltage Vc5 will exceed the reference voltage Vref5 when the length of the period exceeds the period (i.e. when the length of the period is reaching the Mr^{th} bit).

The feature quantity determination circuit 100 is configured such that the counter 101 will be able to perform counting that corresponds to at least an activation quantity Td, based on the activation quantity Td for the first area, and that the logical circuit 102 will have a high output level when the count of the counter 101 coincides with the activation quantity Td.

Similarly, the feature quantity determination circuit 100 is configured such that the counter 103 will be able to perform counting that corresponds to at least an activation quantity Tr, based on the activation quantity Tr for the second area, and that the logical circuit 104 will have a high output level when the count of the counter 103 coincides with the activation quantity Tr.

The feature quantity detection circuit 23a starts operation at a falling edge, i.e. the starting timing, of the stand-by state detection signal DTw.

Then, when a frame in which an ID (ID=0x078 here) assigned for the activation of the ECU 10 in question is sent out to the communication channel LN, an edge of focus that falls on the boundary number Cst (=2) (i.e. Cst^{th} (2^{nd}) edge of focus) occurs, as shown in FIG. 34, at a timing corresponding to the boundary between RTR and a stuff bit inserted immediately after RTR. The edge of focus in this case corresponds to an edge at which the signal level of the reception signal Rsl turns from dominant to recessive. Specifically, with the operation of the end timing detection circuit 90a, the termination signal DTe turns to an active level at a timing delayed from the timing of this edge of focus by about one bit.

The bit pattern of the specific pattern area includes the first area in which a dominant level continues for consecutive Mr (=5) bits and the second area in which a recessive level continues for consecutive Md (=5) bits. Specifically, the bit pattern includes the first area, the second area and the first area juxtaposed in this order. Accordingly, in a period from the start timing to the end timing, the first area detection circuit 70 generates the first area detection clock DCK consisting of two pulse signals, the number being the same as that of the first areas. Also, the second area detection circuit 80 generates the second area detection clock RCK, in this period, consisting of a single pulse signal, the number being the same as that of the second areas.

Thus, the count DCNT of the counter 101 that operates according to the first area detection clock DCK indicates “2”, while the count RCNT of the counter 103 that operates according to the second area detection clock RCK indicates “1”.

Thus, both of the counts DCNT and RCNT (quantities of feature) coincide with the quantities of activation (Td=2, Tr=1), respectively. Therefore, the coincidence detection signal Did turns to an active level at a time point when the second first area is detected and the count RCNT indicates “2” (the count DCNT indicates “1” at a timing earlier than this timing). The signal level is retained until the end timing.

When an ID assigned for the activation of the ECU 10 in question is different from ID=0x078, this means that the boundary number Cst, activation quantities Td and Tr, area widths Md and Mr are all different from those of the ID of the ECU 10 in question. Therefore, the coincidence detection signal Did will not turn to an active level even when the activation frame in which ID=0x078 is set is received.

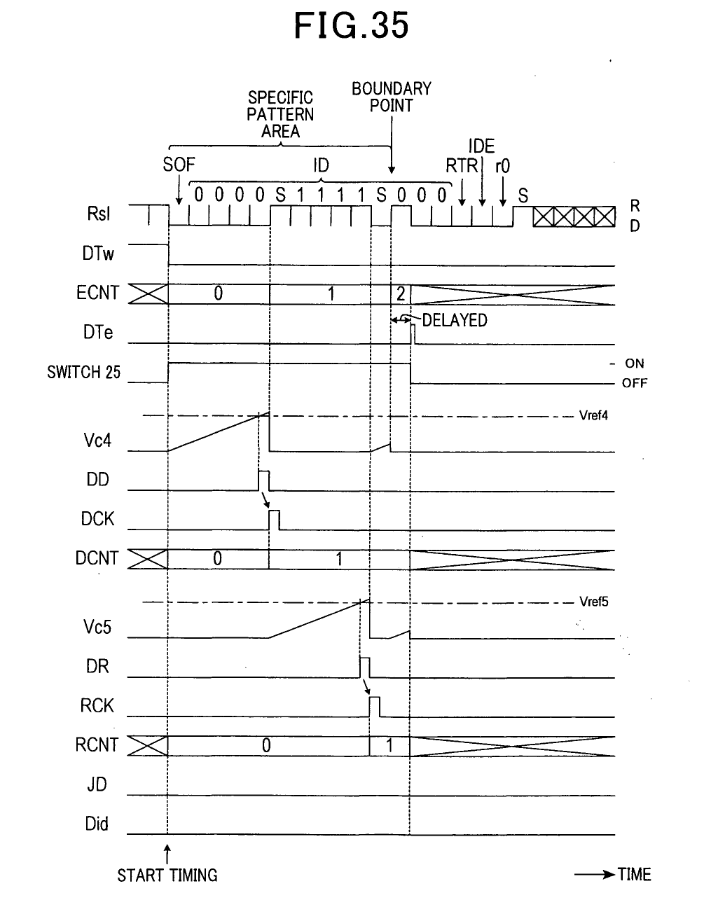

On the other hand, when a frame in which a normal ID (=0x07C) not for activation is sent out to the communication channel LN, an edge of focus that falls on the boundary number Cst (=2) (i.e. Cst^{th} (2^{nd}) edge of focus) occurs, as shown in FIG. 35 at a timing corresponding to the boundary between the 2^{nd} stuff bit inserted in the ID and the 9^{th} bit. Specifically, with the operation of the end timing detection circuit 90a, the termination signal DTe turns to an active level at a timing delayed from the timing of this edge of focus by about one bit.

In this case, in the bit pattern in the specified pattern area, the first area, the second area and one dominant bit are juxtaposed in this order. Accordingly, in a period from the start timing to the end timing, the first area detection circuit 70 generates the first area detection clock DCK consisting of a single pulse signal, the number being the same as that of the first areas. Also, the second area detection circuit 80 generates the second area detection clock RCK, in this period, consisting of a single pulse signal, the number being the same as that of the second areas.

Thus, the count DCNT of the counter 101 and the count RCNT of the counter 103 both indicate “1”. In this case, the count DCNT (=1) does not coincide with the activation quantity Td (=2). Therefore, the coincidence detection signal Did is retained at a non-active level without terming to an active level.

As described above, the present embodiment is different from the fourth embodiment only in the boundary condition used for detecting the boundary point and the ID for activation, which is set in an activation frame. The remaining part of the present embodiment operates completely in the same was as in the fourth and fifth embodiments. Therefore, the same advantages as in the fourth and fifth embodiments can be obtained.

### Modifications

Some embodiments of the disclosure have been described so far. However, the disclosure is not limited to the above embodiments but may be modified and implemented in various manners without departing from the spirit of the disclosure.

For example, in the above embodiment, the receiver 16 is configured by two comparators CP1 and CP2, and the comparators are adapted to be switched depending on the operational modes. Alternative to this, the receiver may be configured by a single comparator CP1, and, as an option, the output of the comparator CP1 may be supplied to the microcomputer 11 as the reception data RxD, or as another option, the output of the comparator CP1 may be supplied to the activation frame detector 17 as the reception signal Rsl. These options may be switched depending on the operational modes.

In the above embodiment, like described before, a stand-by state is determined when a dominant level continues for six or more consecutive bits. However, this may not impose a limitation. For example, the consecutive bits may be N+1 bits or more but may be 11 bits or less, where N is a maximum number of consecutive bits of the same level allowable in a frame with an insertion of stuff bits. It should be appreciated that the 11 bits correspond to the sum of the ACK delimiter (1 bit), the EOF (7 bits) and the intermission (3 bits) inserted between frames.

In this case, however, the activation period length is also required to be changed, which is used for determining whether or not a frame in question is an activation frame.

In the above embodiments, the number of edges of focus, and the number of the first and second areas are used as the quantity of feature. However, the quantity of feature may be the length of the specific pattern area (area from the head of the frame to a point where the boundary condition is met). This may be realized by using a circuit similar to the period-length determination circuit 50.

What is claimed is:

1. A communication system comprising:
a communication line having a stand-by state in which a signal in the communication line has a recessive level which lasts over a period of time corresponding to the number of allowed sequential bits of the signal;
a plurality of nodes communicably connected to the communication line and configured to communicate with each other based on an NRZ (Non Return to Zero) code, each of the nodes detecting, as a head of a data frame transmitted into the communication line, a dominant level of the signal in the communication line when the signal changes to the dominant level during the stand-by state of the communication line, and operating based on, as an operation mode, a sleep mode in which the node stops communication via the communication line and a normal mode in which the node is allowed to perform the communication via the communication line, a predetermined activation frame being transmitted into the communication line during the sleep mode,
wherein the activation frame is produced from the data frame and has an activation pattern area, a specific pattern area, and a boundary position, the activation pattern area storing therein a bit pattern showing that the frame transmitted into the communication line is the activation frame, the specific pattern area storing therein a bit pattern showing a node to be activated among the plurality of nodes, the boundary position satisfying a predetermined boundary condition for the bit pattern in the activation frame and being a boundary between the activation pattern area and the specific pattern area; and
each of the nodes is configured to perform a switchover of the operation mode from the sleep mode to the normal mode based on the bit patterns in the activation pattern area and the specific pattern area and information given by the boundary position.

2. The communication system of claim 1, wherein
the activation frame has the activation pattern area in which a unique bit pattern is provided, the unique bit pattern having a bit length counted from the head of the activation frame to a boundary point, the bit length being different from a predetermined activation period length, the boundary point serving as the boundary position, and
each of the nodes is configured to i) measure the bit length from the head of the activation frame transmitted via the communication line when the operation mode is in the sleep mode, ii) determine whether or not requirements are met, the requirements consisting of a) a requirement that the measured bit length is equal to or greater than the activation period length and b) a requirement that the bit pattern from the specific pattern area of the activation frame agrees with a bit pattern assigned to the node which is in the measurement, the assigned bit pattern designating the node as a node whose operation mode should be switched over from the sleep mode to the normal mode, and iii) allow the operation mode of the node to be switched from the sleep mode to the normal mode.

3. The communication system of claim 2, wherein the activation pattern area is given, as a boundary condition, a bit pattern including a portion consisting of two or more bits which are continuous and have dominant levels and an area located prior to the portion and configured to include bits all of which have recessive levels except for a portion having bits showing dominant levels according to a production rule of the data frame, and
each of the nodes is configured to detect the boundary point meeting the boundary condition.

4. The communication system of claim 2, wherein the production rule includes a provision of inserting a stuff bit into the activation frame when bits having the same levels continue by a predetermined number of amounts, the stuff bit being inverted from a last bit of a directly preceded data frame,
the activation pattern area is given a bit pattern whose edges of focus become minimum in number (K pieces, but K is a positive integer and K≧2), the edges of focus providing a change in the signals from the recessive levels to the dominant levels, and
each of the nodes is configured to detect the boundary point meeting a boundary condition that a K-th targeted edge counted from the head in the activation frame is detected, the K-th edge of focus being among the K-piece edges of focus.

5. The communication system of claim 2, wherein the specific pattern area stores therein signals which are coded every unit block consisting of a plurality of bits.

6. The communication system of claim 2, wherein the communication via the communication line is performed based on a CAN (Controller Area Network) communication protocol such that the data frames are communicated among the nodes,
wherein each of the data frames contains a DLC (data length code) and a date field, an area before the DLC in the data frame is assigned to the activation pattern area and the data field in the data frame is assigned to the specific pattern area.

7. The communication system of claim 1, wherein the frame has a boundary area in which two or more bits which have the same signal level continues,
the activation pattern area is given as an area ranging from the head to the boundary area in the activation frame,
the specific pattern area is given as part of an area ranging from the boundary area to a tail of the activation frame in the activation frame, wherein the specific pattern area has a bit pattern in which bits having the dominant levels and bits having the recessive levels are mapped alternately to each other, and
each of the nodes is configured to i) measure the number of edges to be counted when the operation mode is in the sleep mode, the edges being at least one of an edge at which the signal changes from the recessive level thereof to the dominant level thereof and an edge at which the signal changes from the dominant level thereof to the recessive level thereof, ii) determine whether or not requirements are met, the requirements consisting of a) a requirement that the number of edges counted in the activation pattern area of the activation frame transmitted into the communication line is equal to the number of times of activation defined by the bit patter in the activation pattern area and b) a requirement that the bit pattern from the specific pattern area of the activation frame agrees with a bit pattern assigned to the node which is in the measurement, the assigned bit pattern designating the node as a node whose operation mode should be switched over from the sleep mode to the normal mode, and iii) allow the operation mode of the node to be switched from the sleep mode to the normal mode when it is determined that the requirements are met.

8. The communication system of claim 7, wherein the specific pattern area stores therein signals which are coded every unit block consisting of a plurality of bits.

9. The communication system of claim 7, wherein the communication via the communication line is performed based on a CAN (Controller Area Network) communication protocol such that the data frames are communicated among the nodes,
wherein each of the data frames contains an ID (identifier), a DLC (data length code), an SOF (start of frame) and a data field, an area between the ID and the DLC is assigned to the boundary area, the SOF and the ID are assigned to the activation pattern area, and the data field is assigned to the specific pattern area.

10. The communication system of claim 1, wherein
the activation frame is a first frame having a data area whose bit length is the shortest, the frame including a second frame whose frame length is not the shortest,
the specific pattern area is given as an area ranging from the head of the activation frame to a boundary point serving as the boundary position, and
each of the nodes is configured to i) measure a frame length and an activation period length of the frame transmitted via the communication line when the operation mode is in the sleep mode, ii) determine whether or not requirements are met, the requirements consisting of a) a requirement that the measured frame length is greater than a frame length of the activation frame and lower than or equal to the activation period length of the second frame, and b) a requirement that a feature quantity obtained from the bit pattern in the specific pattern area agrees with a bit pattern assigned to the node which is in the measurement, the assigned bit pattern designating the node as a node whose operation mode should be switched over from the sleep mode to the normal mode, and ii) allow the operation mode of the node to be switched from the sleep mode to the normal mode when it is determined that the requirements are met.

11. The communication system of claim 10, wherein
the specific pattern area has the bit pattern including continuous signals having the same level and being less than N bits (N is a positive integer of 2 or more), and
the boundary condition is set such that that the signals continue by N bits or more.

12. The communication system of claim 10, wherein the feature quantity is the number of edges of focus providing at least one of changes in the signals from the recessive levels to the dominant levels and from the dominant levels to the recessive levels.

13. The communication system of claim 10, wherein an edge of focus is provided as at least one of changes in the signals from the recessive levels to the dominant levels and from the dominant levels to the recessive levels, and
the boundary condition is set such that the edge of focus is detected at a predetermined number-th which is set previously for the boundary point when the signals are counted from the head of the frame.

14. The communication system of claim 11, wherein the feature quantity is a length of the specific pattern area.

15. The communication system of claim 11, wherein the feature quantity is at least one of the number of first areas and the number of second areas, the first and second areas being detected in the specific pattern area,
wherein each of the first areas is given as signals having dominant levels and having a first bit width which is predetermined, and each of the second areas is given as signals having recessive levels and having a second bit width which is predetermined.

16. The communication system of claim 10, wherein the communication via the communication line is performed based on a CAN (Controller Area Network) communication protocol such that the data frames are communicated among the nodes,
wherein each of the data frames contains a DLC (data length code), and the data frame whose DLC is set to 0 is used as the activation frame.

17. A transceiver incorporated in a communication system comprising:
a communication line having a stand-by state in which a signal on the communication line has a recessive level which lasts over a period of time corresponding to the number of allowed sequential bits of the signal which is a maximum number of sequential bits having the same signal level which is allowed by a production rule of the frame to be transmitted via the communication line; and
a plurality of nodes communicably connected to the communication line and configured to communication with each other based on an NRZ (Non Return to Zero) code, each of the nodes detecting, as a head of a data frame transmitted into the communication line, a dominant level of the signal on the communication line when the signal changes to the dominant level during the stand-by state of the communication line, and operating based on, as an operation mode, a sleep mode in which the node stops communication via the communication line and a normal mode in which the node is allowed to perform the communication via the communication line, a predetermined activation frame being transmitted into the communication line during the sleep mode,
wherein the transceiver is incorporated in each of the nodes to transmit and receive the signals via the communication line,
the transceiver comprising:
start timing detecting means that first detects a start timing at which the signal level on the communication line changes to the dominant level thereof during the stand-by state of the communication line; and
wake-up control means wakes up the transceiver when a physical characteristic of the frame transmitted via the communication line meets a predetermined condition defined based on reference information relative to the physical characteristic.

18. The transceiver of claim 17, wherein the wake-up control means includes:
end timing detecting means that detects an end timing at which the bit patterns of the frame meets a predetermined boundary condition after the start timing is detected during the sleep mode;
period determining means that determines whether or not a period of time from the start timing to the end timing is equal to or larger than a predetermined activation period length; and
comparing means that compares a code pattern in the specific pattern area of the activation frame with a predetermined pattern when it is determined by the period determining means that the period of time is equal to or larger than the predetermined activation period length, whereby a wake-up signal showing that the receiver has received the activation frame is outputted from the comparing means when the code pattern coincides with the predetermined pattern.

19. The transceiver of claim 18, wherein the end timing detecting means adopts, as the boundary condition, a bit pattern consisting of two or more bits which are continuous and have dominant levels in the frame.

20. The transceiver of claim 19, wherein the end timing detecting means includes:
a first capacitive element into and from which electric charge is chargeable or dischargeable; and
a first charging circuit that resets a charge voltage of the first capacitive element to an, initial voltage thereof when the signal on the communication line has the recessive level and charges the first capacitive element with a charging current of which amplitude is constant, when the signal on the communication line has the dominant level,
wherein the end timing detecting means is configured to detect the bit pattern consisting of two or more sequential bits by comparing a voltage threshold with the charge voltage of the first capacitive element, the voltage threshold being set to a voltage corresponding to the charge voltage of the first capacitive element which is obtained when charging performed by first charging circuit continues more than a period of time corresponding to 2 bits.

21. The transceiver of claim 18, wherein the end timing detecting means is configured to detect the end timing based on, as the boundary condition, a condition that the number of edges of focus started to be counted from a head of the frame reaches a predetermined number, the signal changing at each of the edges of focus from the recessive level to the dominant level.

22. The transceiver of claim 18, wherein the period determining means includes:
a second capacitive element into and from which electric charge is chargeable or dischargeable; and
a second charging circuit that resets a charge voltage of the second capacitive element to an initial voltage thereof when the communication line is in the stand-by state and charges the second capacitive element with a charging current of which amplitude is constant, when the communication line is in a state other than the stand-by state; and
voltage comparing means that compares a period threshold with the charge voltage of the second capacitive element in order to determine whether or not the period of time from the start timing is equal to or larger than the predetermined activation period length, the period threshold whose amplitude corresponds to the charge voltage of the second capacitive element which is obtained when charging performed by second charging circuit continues more than the activation period length.

23. The transceiver of claim 18, wherein the start timing detecting means includes:
a third capacitive element into and from which electric charge is chargeable or dischargeable;
a third charging circuit that resets a charge voltage of the third capacitive element to an initial voltage thereof when the signal on the communication line has the dominant level and charges the third capacitive element with a charging current of which amplitude is constant, when the signal on the communication line has the recessive level; and
stand-by state determining means whether or not the communication line is in the stand-by state by comparing a threshold assigned to stand-by state determination with the charge voltage of the third capacitive element, the threshold assigned to the stand-by state determination having an amplitude corresponding to the charge voltage of the third capacitive element which is obtained when charting the third charging circuit continues more than a period of time corresponding to the number of allowable sequential bits.

24. The transceiver of claim 18, wherein
the code pattern includes a plurality of signals which are divided by edges of focus and the signals are patterned based on two types of bit patterns having mutually different duty ratios, each of the edges of focus being either one of an edge at which the signals change from the recessive levels thereof to the dominant levels thereof and an edge at which the signals change from the dominant levels thereof to the recessive levels thereof, and
the comparing means includes
a fourth capacitive element into and from which electric charge is chargeable or dischargeable;
a fourth charging circuit that i) charges and discharges the fourth capacitive element with a positive charge current having a constant amplitude and a negative charge current having a constant amplitude, both the positive and negative charge currents being supplied to the fourth capacitive element alternately every time the signals on the communication line change levels thereof and ii) resets a charge voltage of the fourth capacitive element to an initial voltage every time the edge of focus is detected, and
pattern determination means that determines whether or not the charge voltage of the fourth capacitive element which is obtained before resetting the fourth capacitive circuit is larger than a predetermined threshold assigned to code determination in order to detect that the code pattern corresponds to any one of 0 and 1.

25. The transceiver of claim 23, wherein the comparing means includes:
a clock generation circuit that generates a clock in synchronism with the received frame, based on the signals on the communication line, and
a decode circuit that decodes in response to the generated clock.

26. A node comprising:
a transceiver according to claim 18;
communication control means that transmits and receives the signals via the transceiver; and
operation mode changing means that i) changes the operation mode to the sleep mode when a predetermined sleep condition is met during the normal mode, and ii) returns the operation mode to the normal mode when the wake-up signal is outputted from the transceiver during the sleep mode.

27. The transceiver of claim 17, wherein the wake-up control means includes:
end timing detecting means that detects an end timing at which the frame shows a bit pattern composed of two or more sequential bits each having the dominant level;
edge counting means that counts the number of edges generated from a period of time from the start timing to the end timing first detected by the end timing detecting means, the edges being at least one of an edge at which the signal on the communication line changes from the recessive level to the dominant level and an edge at which the signal on the communication line changes from the dominant level to the recessive level;
edge determining means that determines whether or not the counted number of edges is equal to a predetermined number of times of activation; and
comparing means that compares a code pattern shown in the specific pattern area of the frame with a predetermined pattern when it is determined by the edge determining means that the counted number of edges is equal to the predetermined number of times required to cause activation, whereby a wake-up signal showing that the receiver has received the activation frame is outputted from the comparing means when the code pattern coincides with the predetermined pattern.

28. The transceiver of claim 27, wherein the start timing detecting means
a first capacitive element into and from which electric charge is chargeable or dischargeable;
a first charging circuit that resets a charge voltage of the first capacitive element to an initial voltage thereof when the signal on the communication line has the dominant level and charges the first capacitive element with a charging current of which amplitude is constant, when the signal on the communication line has the recessive level; and
stand-by state determining means whether or not the communication line is in the stand-by state by comparing a threshold assigned to stand-by state determination with the charge voltage of the first capacitive element, the threshold assigned to the stand-by state determination having an amplitude corresponding to the charge voltage of the first capacitive element which is obtained when charting the first charging circuit continues more than a period of time corresponding to the number of allowable sequential bits.

29. The transceiver of claim 27, wherein the end timing detecting means includes:
a second capacitive element into and from which electric charge is chargeable or dischargeable; and
a second charging circuit that resets a charge voltage of the second capacitive element to an initial voltage thereof when the signal on the communication line has the recessive level and charges the second capacitive element with a charging current of which amplitude is constant, when the signal on the communication line has the dominant level,
wherein the end timing detecting means is configured to detect the end timing by comparing a voltage threshold with the charge voltage of the second capacitive element, the voltage threshold being set to a voltage corresponding to the charge voltage of the second capacitive element which is obtained when charging performed by second charging circuit continues more than a period of time corresponding to 2 bits.

30. The transceiver of claim 27, wherein
the code pattern includes a plurality of signals which are divided by edges of focus and the signals are patterned based on two types of bit patterns having mutually different duty ratios, each of the edges of focus being either one of an edge at which the signals change from the recessive levels thereof to the dominant levels thereof and an edge at which the signals change from the dominant levels thereof to the recessive levels thereof, and
the comparing means includes
a third capacitive element into and from which electric charge is chargeable or dischargeable;
a third charging circuit that i) charges and discharges the third capacitive element with a positive charge current having a constant amplitude and a negative charge current having a constant amplitude, both the positive and negative charge currents being supplied to the third capacitive element alternately every time the signals on the communication line change levels thereof and ii) resets a charge voltage of the third capacitive element to an initial voltage every time the edge of focus is detected, and
pattern determination means that determines whether or not the charge voltage of the third capacitive element which is obtained before resetting the third capacitive circuit is larger than a predetermined threshold assigned to code determination in order to detect that the code pattern corresponds to any one of 0 and 1.

31. The transceiver of claim 27, wherein the comparing means includes:
a clock generation circuit that generates a clock in synchronism with the received frame, based on the signals on the communication line, and
a decode circuit that decodes in response to the generated clock.

32. A node comprising:
a transceiver according to claim 27;
communication control means that transmits and receives the signals via the transceiver; and
operation mode changing means that i) changes the operation mode to the sleep mode when a predetermined sleep condition is met during the normal mode, and ii) returns the operation mode to the normal mode when the wake-up signal is outputted from the transceiver during the sleep mode.

33. A transceiver of claim 17, comprising stand-by state detecting means that detects the stand-by state,
wherein the start timing detecting means is configured to detect, as the start timing, a timing at which the signal on the communication line first changes to the dominant level after the stand-by detecting means detects the stand-by state during the sleep mode; and
the wake-up control means includes:
frame length measuring means that measures a period of time from the start timing to a timing at which the stand-by state detecting means detects the stand-by state again;
frame length determining means that determines whether or not i) the measured period of time is larger than a frame length of a shortest frame and ii) the measured period of time is less than an activation period length which is set to be less than a shortest frame length of a non-shortest frame, the shortest frame being produced from the frame so as to have a shortest data area, the non-shortest frame being other than the shortest frame among the frames;
boundary point detecting means that detects a boundary point in a bit pattern of the frame, the boundary point meeting a predetermined boundary condition when the start timing is detected;
feature quantity obtaining means that obtaining a given feature quantity from a bit pattern of a specific pattern area of the frame, the specific pattern area being an area from a position decided by the start timing in the frame to the detected boundary point;
feature quantity determining means that determines whether or not the feature quantity coincides with a predetermined quantity assigned to the activation; and
output means that outputs a wake-up signal showing that the receiver has received the activation frame when the measured period of time is less than the activation period length and the determined feature quantity coincides with the predetermined quantity assigned to the activation.

34. The transceiver of claim 33, wherein the boundary condition is set such that that the signals continue by N bits or more (N is a positive integer of 2 or more).

35. The transceiver of claim 34, wherein the boundary point detecting means includes:
a first capacitive element into and from which electric charge is chargeable or dischargeable; and
a first charging circuit that charges the first capacitive element with a charging current of which amplitude is constant, when the signal on the communication line is a first signal, and resets a charge voltage of the first capacitive element to an initial voltage thereof when the signal on the communication line is a second signal level, wherein any one of the signals having the recessive and dominant levels is the first signal and the other is the second signal,
wherein the boundary point detecting means is configured to detect a bit pattern consisting of the first signal of two or more sequential bits by comparing a voltage threshold with the charge voltage of the first capacitive element, the voltage threshold being set to a voltage corresponding to the charge voltage of the first capacitive element which is obtained when charging performed by the first charging circuit continues more than a period of time corresponding to 2 bits.

36. The transceiver of claim 33, wherein the feature quantity determining means includes a counter that counts the number of edges of focus, the number of edges of focus providing at least one of changes in the signals from the recessive level to the dominant level and from the dominant level to the recessive level.

37. The transceiver of claim 33, wherein an edge of focus is provided as at least one of changes in the signal from the recessive level to the dominant level and from the dominant level to the recessive level, and
the boundary condition is set such that the edge of focus is detected at a predetermined number-th which is set previously for the boundary point when the signals are counted from the head of the frame.

38. The transceiver of claim 37, wherein the feature quantity determining means is configured to adopts, as the feature quantity, at least one of the number of first areas detected in the specific pattern area and the number of second areas detected in the specific pattern area, each of the first areas including the signal with the dominant level and having a predetermined first bit width, each of the second areas including the signal with the recessive level and having a predetermined second bit width.

39. The transceiver of claim 33, wherein the frame length determining means includes:
a second capacitive element into and from which electric charge is chargeable or dischargeable; and
a second charging circuit that resets a charge voltage of the second capacitive element to an initial voltage thereof when the communication line is in the stand-by state and charges the second capacitive element with a charging current of which amplitude is constant, when the communication line is in a state other than the stand-by state; and
voltage comparing means that compares a period threshold with the charge voltage of the second capacitive element in order to determine whether or not the period of time from the start timing is equal to or larger than the predetermined activation period length, the period threshold whose amplitude corresponds to the charge voltage of the second capacitive element which is obtained when charging performed by second charging circuit continues more than the activation period length.

40. The transceiver of claim 33, wherein the stand-by state detecting means includes:
a third capacitive element into and from which electric charge is chargeable or dischargeable;
a third charging circuit that resets a charge voltage of the third capacitive element to an initial voltage thereof when the signal on the communication line has the dominant level and charges the third capacitive element with a charging current of which amplitude is constant, when the signal on the communication line has the recessive level; and
stand-by state determining means whether or not the communication line is in the stand-by state by comparing a threshold assigned to stand-by state determination with the charge voltage of the third capacitive element, the threshold assigned to the stand-by state determination having an amplitude corresponding to the charge voltage of the third capacitive element which is obtained when charting the third charging circuit continues more than a period of time corresponding to the number of allowable sequential bits.

41. A node comprising:
a transceiver according to claim 33;
communication control means that transmits and receives the signals via the transceiver; and
operation mode changing means that i) changes the operation mode to the sleep mode when a predetermined sleep condition is met during the normal mode, and ii) returns the operation mode to the normal mode when the wake-up signal is outputted from the transceiver during the sleep mode.
